(19) United States
(12) Patent Application Publication
(10) Pub. No.: US 2019/0220133 A1
(43) Pub. Date: Jul. 18, 2019

(54) DISPLAY DEVICE AND METHOD FOR TOUCH INTERFACE

(71) Applicant: SAMSUNG ELECTRONICS CO., LTD., Suwon-si (KR)

(72) Inventors: Sangjin HAN, Suwon-si (KR); Jeannie Kang, Suwon-si (KR); Donghyuk Kim, Suwon-si (KR)

(73) Assignee: SAMSUNG ELECTRONICS CO., LTD., Suwon-si (KR)

(21) Appl. No.: 16/248,071

(22) Filed: Jan. 15, 2019

(30) Foreign Application Priority Data
Jan. 15, 2018 (KR) 10-2018-0004860

(51) Int. Cl. G06F 3/041; G06F 3/0488; G06F 3/0484; G06F 3/0482

(52) U.S. Cl. CPC G06F 3/0416; G06F 3/04883; G06F 3/04886; G06F 3/0482; G06F 3/04847

(57) ABSTRACT

A display device is provided. The display device includes a display, a front plate that includes a displaying area exposing a portion of the display and a non-displaying area forming a border of the display, a sensor circuit that senses a touch by an external subject to the displaying area and the non-displaying area, and a processor.

### CROSS-REFERENCE TO RELATED APPLICATION(S)

This application is based on and claims priority under 35 U.S.C. § 119 to Korean Patent Application No. 10-2018-0004860, filed on Jan. 15, 2018, in the Korean Intellectual Property Office, the disclosure of which is incorporated by reference herein its entirety.

### BACKGROUND

### 1. Field

The disclosure relates to a technology for a touch interface.

### 2. Description of Related Art

A display device may include a touch sensor and may sense a touch of a user through the touch sensor. The touch sensor may include a resistive touch sensor, a capacitive touch sensor, an infrared touch sensor, and the like. A large-screen display device mainly uses the infrared touch sensor.

When user's finger, a pen, or the like contacts an infrared matrix composed of a plurality of light emitting elements and a plurality of photodetectors, the infrared touch sensor may recognize a location where an infrared light is blocked, as a touch location.

However, a touch sensor (e.g., an infrared touch sensor) of a display device of the related art may sense only a touch by an external subject, which is made in an exposure area of a display.

The above information is presented as background information only to assist with an understanding of the disclosure. No determination has been made, and no assertion is made, as to whether any of the above might be applicable as prior art with regard to the disclosure.

### SUMMARY

Provided is a display device which may sense a touch by an external subject to a frame area and may provide an interface associated with the touch and a touch interface method thereof.

In accordance with an aspect of the disclosure, a display device may include a display including a displaying area which a plurality of pixels is disposed and a non-displaying area forming a border of the display, wherein the plurality of pixels is not disposed on the non-displaying area, a sensor circuit configured to sense a touch by an external subject to the displaying area and the non-displaying area, and a processor configured to based on a first touch by the external subject to the displaying area being sensed through the sensor circuit, perform a drawing function corresponding to the first touch, and based on a second touch by the external subject to the non-displaying area being sensed through the sensor circuit, determine a type of the second touch, and control the display to perform a control function based on the type of the second touch.

In accordance with another aspect of the disclosure, a touch interface method of a display device which includes a display device which comprises a display including a displaying area which a plurality of pixels is disposed and a non-displaying area forming a border of the display, and a sensor circuit, wherein the plurality of pixels is not disposed on the non-displaying area, the method comprising based on a first touch by an external subject to the displaying area being sensed through the sensor circuit, performing a drawing function corresponding to the first touch, and based on a second touch by the external subject to the non-displaying area being sensed through the sensor circuit, determining a type of the second touch and updating and displaying the current page based on the type of the second touch, and controlling the display to perform a control function based on the type of the second touch.

In accordance with another aspect of the disclosure, a display device may include a display, a front plate that includes a first area exposing a portion of the display and a second area forming a border of the display, a sensor circuit that senses a touch by an external subject to the first area and the second area, and a processor configured to control the display to display, in a drawing mode, a current page among all pages, to perform, based on a first touch by the external subject to the first area being sensed through the sensor circuit, a drawing function corresponding to the first touch, and control the display to update and display the current page based on a swipe of the external subject to the second area being sensed while a second touch by the external subject to the second area is sensed.

According to embodiments of the disclosure, a touch by an external subject to a frame area of a display may be sensed through a sensor circuit, and an interface associated with the touch may be provided.

Besides, a variety of effects directly or indirectly understood through this disclosure may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a front view of a display device, according to an embodiment;

FIG. 2A is a perspective view of a first surface of a display device, according to an embodiment;

FIG. 2B is a perspective view of a second surface of a display device, according to an embodiment;

FIG. 2C is a view illustrating the arrangement of light emitting elements and photodetectors of an infrared touch sensor, according to an embodiment;

FIG. 3 is a view illustrating a configuration of a display device, according to an embodiment;

FIG. 4 illustrates UI screens associated with a process of performing a scroll operation based on a swipe, according to an embodiment;

FIG. 5 illustrates an UI screen associated with a page scroll process corresponding to a multi-touch, according to an embodiment;

FIGS. 6A and 6B illustrate UI screens associated with a process of performing a clear function, according to an embodiment;

FIGS. 7A and 7B are views for describing a process of enlarging a page based on a touch of a pinch type, according to an embodiment;

FIGS. 8A, 8B, 8C, 8D, 8E, 8F, and 8G are views for describing at least one function menu associated with a plurality of sub-areas included in a frame area, according to an embodiment;

FIG. 9 is a diagram for describing a process of displaying a function menu based on a touch, according to an embodiment;

FIG. 10 is a view for describing a method for displaying a function menu corresponding to a touch location, according to an embodiment;

FIG. 11 is a view for describing a method for displaying a function menu based on a swipe direction, according to an embodiment;

FIGS. 12A and 12B are views for describing a menu scroll method, according to an embodiment;

FIG. 12C is a view for describing a method for scrolling a menu based on a swipe direction, according to an embodiment;

FIG. 13 is a view for describing a function executing method for each swipe direction, according to an embodiment;

FIGS. 14A, 14B, and 14C are views for describing various scroll functions based on a multi-touch, according to an embodiment;

FIG. 15 is a view for describing a method for executing a function based on a touch of a swipe type while playing content, according to an embodiment;

FIGS. 16A and 16B are views for describing how to execute a function based on a touch of a frame area in a standby mode (or a screen saver mode), according to an embodiment;

FIG. 17 is a flowchart illustrating a method for executing a function based on a touch sensing area, according to an embodiment;

FIG. 18 is a flowchart illustrating a method for executing a function based on a touch type, according to an embodiment;

FIG. 19 is a flowchart illustrating a method for scrolling a page based on a swipe, according to an embodiment;

FIG. 20 is a flowchart illustrating a method for executing a scroll function and a clear function, according to an embodiment;

FIG. 21 is a flowchart illustrating a method for displaying a function menu based on a touch, according to an embodiment; and

FIG. 22 is a flowchart illustrating a method for displaying a function menu based on a swipe, according to an embodiment.

### DETAILED DESCRIPTION

Hereinafter, various embodiments of the disclosure may be described with reference to accompanying drawings. However, those of ordinary skill in the art will recognize that modification, equivalent, and/or alternative on the various embodiments described herein can be variously made without departing from the scope and spirit of the disclosure.

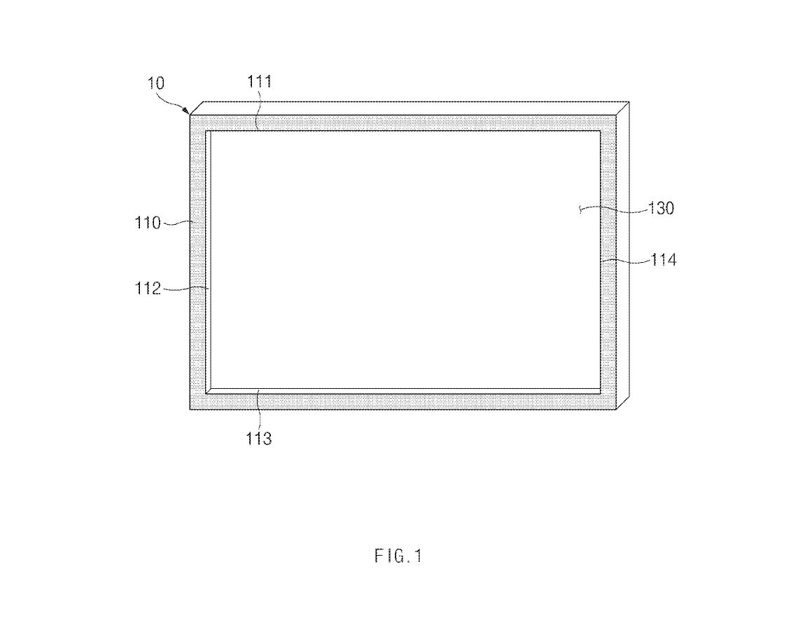

FIG. 1 is a front view of a display device, according to an embodiment.

Referring to FIG. 1, a display device 10 may include a sensor circuit (e.g., an infrared touch sensor) on inner side surfaces 111 to 114 of a black matrix (BM) area 110 covering the border of a display 130. For example, a plurality of light emitting elements and a plurality of photodetectors of the infrared touch sensor may be arranged on the inner side surfaces 111 to 114 of the BM area 110 so as to face each other. In this case, the display device 10 may sense a touch of an external subject (e.g., a finger, a pen, or the like) only in an exposure area of the display 130.

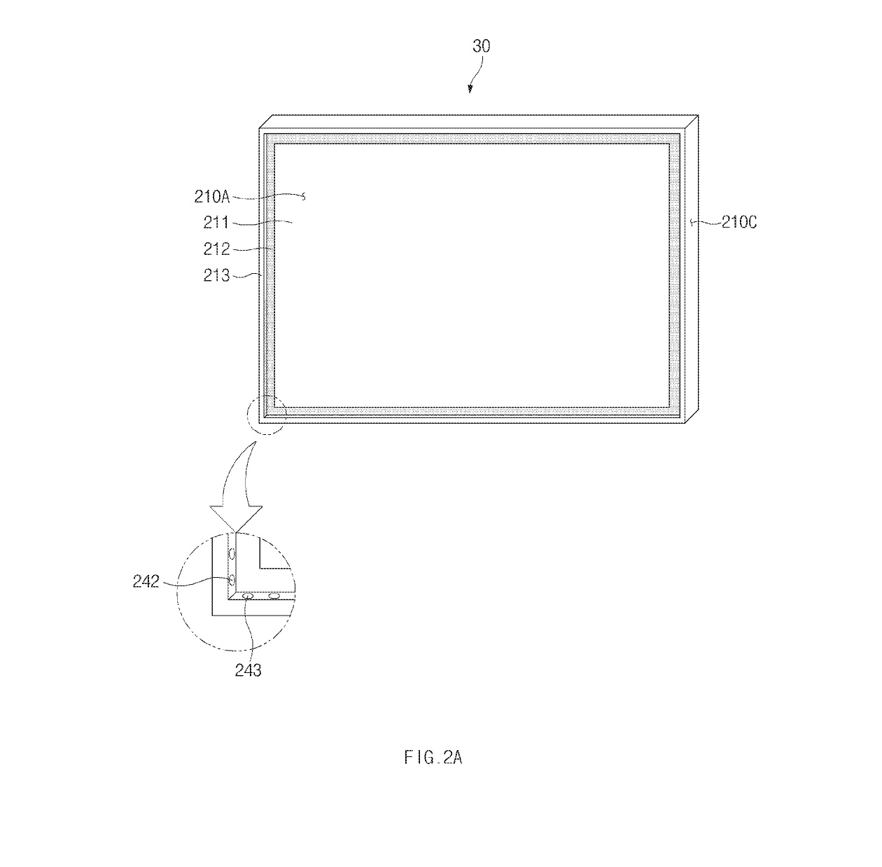

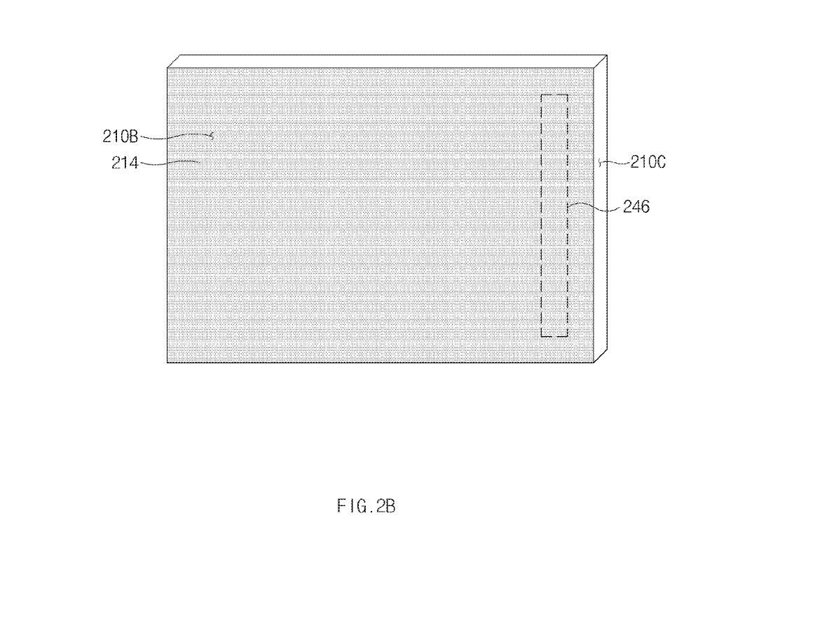

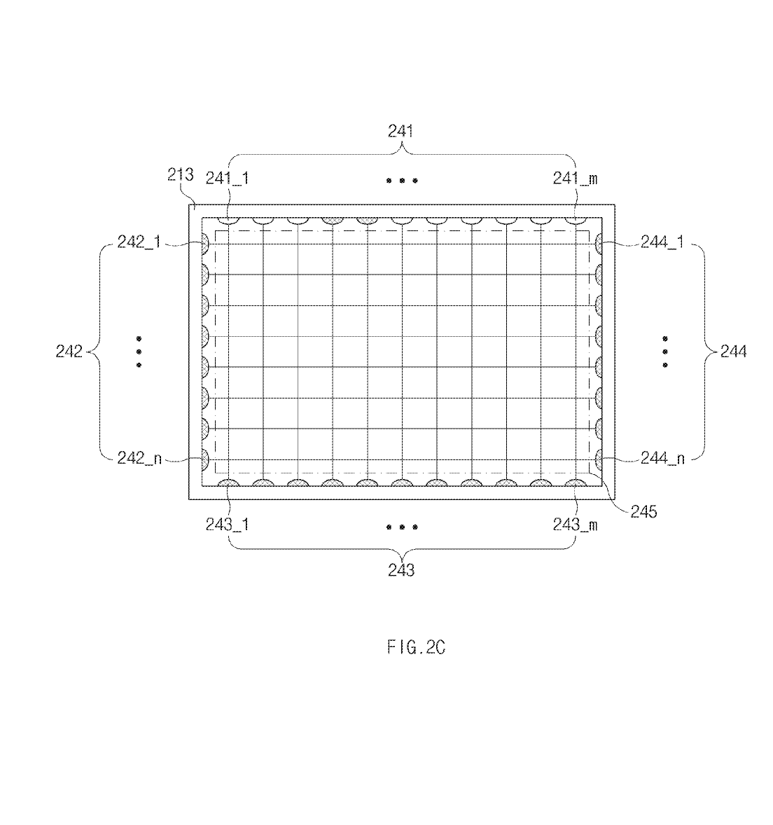

FIG. 2A is a perspective view of a first surface of a display device, according to an embodiment, and FIG. 2B illustrates a perspective view of a second surface of a display device, according to an embodiment.

Referring to FIGS. 2A and 2B, according to an embodiment, a display device 30 may include a housing (210A, 210B, 210C) including a first surface (or a front surface) 210A, a second surface (or a back surface) 210B, and a side surface 210C surrounding a space between the first surface 210A and the second surface 210B.

The first surface 210A may be formed by a front plate (211, 212, 213), which includes a displaying area 211 which is substantially transparent, and a non-displaying area 212 and a third area 213 which are substantially opaque. The displaying area 211 may expose a display area of a display. The non-displaying area 212 and the third area 213 may constitute a BM area (e.g., 110 of FIG. 1) corresponding to at least a portion of the border (or a non-display area) of the display. The non-displaying area 212 may correspond to an inner border of the BM area, and the third area 213 may correspond to an outer border of the BM area. A height of the third area 213 may exceed a height of the non-displaying area 212. The display device 30 may include an infrared touch sensor, and a plurality of light emitting elements and a plurality of photodetectors for forming an infrared matrix may be arranged on an inner side surface of the third area 213. For example, in the case where the plurality of light emitting elements and the plurality of photodetectors are arranged in the third area 213, the infrared touch sensor may sense a touch to the displaying area 211 and the non-displaying area 212. A plurality of pixels is disposed on the displaying area 211, but the plurality of pixels is not disposed on the non-displaying area 212.

The second surface 210B may be formed by a back plate 214 which is substantially opaque. The back plate 214 may cover a back surface of the display. The third surface 210C may be integrally formed with the front plate (211, 212, 213) or the back plate 214.

FIG. 2C is a view illustrating the arrangement of light emitting elements and photodetectors of an infrared touch sensor, according to an embodiment.

Referring to FIGS. 2B and 2C, according to an embodiment, an infrared touch sensor may include a plurality of light emitting elements 241 and 242, a plurality of photodetectors 243 and 244, and a decoder 246.

The plurality of light emitting elements 241 and 242 may be arranged on a first side surface (e.g., an upper side surface) and a second side surface (e.g., a left side surface) of a third area (e.g., 213 of FIG. 2A). The plurality of photodetectors 243 and 244 may be arranged on a third side surface (e.g., a lower side surface) and a fourth side surface (e.g., a right side surface) of the third area so as to receive an infrared light emitted from the plurality of light emitting elements 241 and 242. An infrared matrix 245 (or a touch sensing area) defined by the plurality of light emitting elements 241 and 242 and the plurality of photodetectors 243 and 244 may include the displaying area 211 and the non-displaying area 212. Below, for convenience of description, the displaying area 211 is referred to as a “transparent area” or a “first area”, and the non-displaying area 212 is referred to as a “frame area” or a “second area”. According to the above embodiment, the infrared touch sensor may sense a touch to a display area (e.g., 211) of the display and a portion (e.g., 212) of the BM area.

The decoder 246 may verify the intensity of light received through the plurality of photodetectors 243 and 244, and may determine a touch location of an external subject based on variations in the intensity of light. For example, the decoder 246 may be interposed between the third area 213 of the front plate (211, 212, 213) and the back plate 214.

The case where the display device 30 includes an infrared touch sensor is described above with reference to FIGS. 1 to 2C, but the display device 30 may include various types of touch sensors. In this case, a touch sensor may be positioned within a partial area (e.g., 212) of the BM area, for example, on or under a non-display area corresponding to the border of the display.

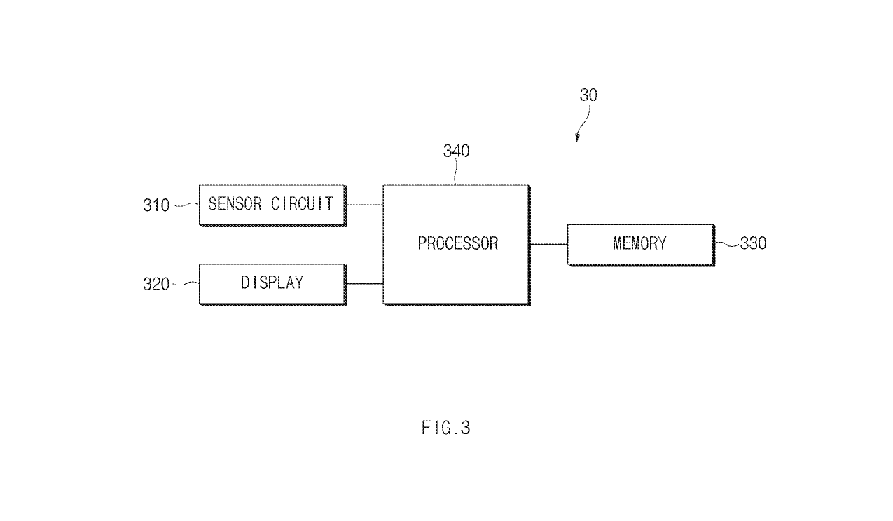

FIG. 3 is a view illustrating a configuration of a display device according to an embodiment.

Referring to FIG. 3, according to an embodiment, the display device 30 may include a sensor circuit 310, a display 320, a memory 330, and a processor 340. In an embodiment, the display device 30 may not include some of the above components or may further include any other components. In an embodiment, some components may be combined to form one entity, which may identically perform functions of some components before the combination. An input/output relationship illustrated in the embodiment of FIG. 3 is only an example, and various embodiments of the disclosure are not limited to illustration of FIG. 3. The display device 30 may include at least one of, for example, a television (TV), a monitor, a notebook computer, a large format display (LFD), a desktop personal computer (PC), a laptop PC, a netbook computer, and a digital photo frame.

According to an embodiment, the sensor circuit 310 may sense a touch to a touch sensing area of a front plate (e.g., 211 to 213 of FIG. 2A) of the display device 30, for example, a touch to the transparent area 211 and the frame area 212. The transparent area 211 may correspond to an area, which exposes the display 320, of the front plate (211, 212, 213). The frame area 212 may correspond to an inner border of a BM area (e.g., 110 of FIG. 1) indicating the border of the display 320. The sensor circuit 310 may be, for example, an infrared touch sensor (e.g., 241 to 245 of FIG. 2A). The sensor circuit 310 may be a touch sensor of any other scheme (e.g., a resistive touch sensor, a capacitive touch sensor, or the like).

According to an embodiment, the display 320 may display various content (e.g., a text, an image, a video, an icon, a symbol, and/or the like) to a user. For example, in a drawing mode, the display 320 may display various content drawn or added by a touch of the user, under control of the processor 340. The display 320 may include, for example, a liquid crystal display (LCD), a light-emitting diode (LED) display, an organic LED (OLED) display, or the like.

According to an embodiment, the memory 330 may store, for example, instructions or data associated with at least another component of the display device 30. For example, the memory 330 may store first mapping information between sub-areas included in the frame area 212 and a plurality of function menus. As another example, the memory 330 may store second mapping information between a plurality of swipe directions and a plurality of function menus. The memory 330 may be a volatile memory (e.g., a random access memory (RAM) or the like), a nonvolatile memory (e.g., a read only memory (ROM), a flash memory, or the like), or a combination thereof.

According to an embodiment, the processor 340 may perform data processing or an operation associated with a control and/or a communication of at least one other component(s) of the display device 30 by using instructions stored in the memory 330. The processor 340 may display a current page of all pages in the display area in the drawing mode, may perform a drawing function when a touch of the external subject to the transparent area 211 is sensed through the sensor circuit 310, and may update and display the current page based on a type of the sensed touch when a touch of the external subject to the frame area 212 is sensed through the sensor circuit 310. For example, the processor 340 may include at least one of a central processing unit (CPU), a graphic processing unit (GPU), a microprocessor, an application processor (AP), and an application specific integrated circuit (ASIC), a field programmable gate arrays (FPGA) and may have a plurality of cores.

According to an embodiment, the processor 340 may display a current page of all pages for drawing in the display 320 in the drawing mode; when a touch of the external subject to the transparent area 211 is sensed through the sensor circuit 310, the processor 340 may perform a drawing function associated with a location of the sensed touch. The drawing mode may include, for example, a mode (e.g., an electronic board mode) to support a drawing function. The drawing function may include a function of drawing a picture, writing a letter, and the like along user's touch. The current page may be, for example, a default page or a lastly selected page. Each of the pages may have a size enough to be displayed on one screen of the display 320.

According to an embodiment, when a touch of the external subject to the frame area 212 is sensed through the sensor circuit 310, the processor 340 may further verify a type of the sensed touch in addition to the location (e.g., a coordinate value) of the sensed touch. The external subject may include, for example, user's finger, user's palm, a pen, or the like. The touch type may include at least one of a swipe type, a pinch type, or a one-point touch type. For example, in the case where a touch location moves in a state where a finger or palm is touched on a touch sensing area (e.g., left right or top bottom), the processor 340 may determine the touch type as the swipe type. As another example, in the case where a distance between two points of the touch sensing area increases in a state where the two points are touched, the processor 340 may determine the touch type as the pinch type. As another example, in the case where one point of the frame area 212 is touched during a specified time or more, the processor 340 may determine the touch type as the one-point touch type.

According to an embodiment, when the touch type is the swipe type, the processor 340 may scroll a current page so as to correspond to a swipe direction and a swipe distance. For example, when the swipe direction is a direction from the left to the right, the current page may be scrolled in a direction from the left to the right. When the swipe direction is a direction from the right to the left, the current page may be scrolled in a direction from the right to the left. As another example, when the swipe direction is a direction from the top to the bottom, the current page may be scrolled in a direction from the top to the bottom. When the swipe direction is a direction from the bottom to the top, the current page may be scrolled in a direction from the bottom to the top. The processor 340 may verify a distance of the swipe and may scroll the current page as much as the verified distance.

According to an embodiment, when a type of a touch to the frame area 212 is the swipe type, the processor 340 may further verify a touch area of the external subject; when the touch area is a specified area or larger, the processor 340 may clear the current page or at least a portion of all the pages. The specified area may be set to such an extent as to distinguish a finger touch and a palm touch. For example, the specified area may be set to an intermediate value of an average area of the finger touch and an average area of the palm touch. For example, when the touch area is the specified area or larger, the processor 340 may clear the current page or at least a portion of all the pages depending on a direction of the swipe. When the swipe direction is a first direction (e.g., a direction perpendicular to a page-enumerated direction), the processor 340 may clear an area corresponding to the swipe in the current page. When a direction of the swipe is a second direction (e.g., a page-enumerated direction), the processor 340 may clear a page, which corresponds to the swipe, from among all the pages, for example, for each page. In an embodiment, when the verified touch area is smaller than the specified area, the processor 340 may scroll the current page so as to correspond to a direction and a length of the swipe. Upon scrolling the current page, the processor 340 may scroll the current page as much as the length of the swipe.

According to an embodiment, when a type of a touch to the frame area 212 is a pinch type in which a distance between two touched points increases, the processor 340 may enlarge an area of the current page, which corresponds to the two points, as much as a magnification corresponding to the distance between the two points. For example, when a touch of a pinch type in which two points of an upper area or a lower area of the frame area 212 are touched and then a distance between the two points increases from side to side, the processor 340 may enlarge the current page as much as a magnification corresponding to the degree by which the distance between the two points increases, with respect to an imaginary line passing through a point, which is centered between the two points, of the whole area of the current page. The imaginary line may be a line passing through the center point and parallel to a pixel column of the display 320. For example, when a touch of a pinch type in which two points of a left side area or a lower side area of the frame area 212 are touched and then a distance between the two points increases from side to side, the processor 340 may enlarge the current page as much as a magnification corresponding to the degree by which the distance between the two points increases, with respect to an imaginary line passing through a point, which is centered between the two points, of the whole area of the current page. The imaginary line may be a line passing through the centered point and parallel to a pixel row of the display 320.

According to an embodiment, when a double tap touch to the frame area 212 is sensed in a state where there is enlarged an area of the current page, which corresponds to two points associated with a touch manipulation of a pinch type, the processor 340 may reduce the area corresponding to the two points to a specified magnification (e.g., xl). For example, as the area corresponding to two points is reduced to the specified magnification (e.g., xl), the processor 340 may display the current page before enlargement.

According to an embodiment, while the current page is updated, the processor 340 may overlay map information for indicating a location of the current page of all the pages on the current page. For example, while the current page is updated depending on scroll, enlargement, or reduction, the processor 340 may overlay and display the map information for indicating the location of the current page of all the pages on the right bottom of the current page.

According to an embodiment, when a type of a touch to the frame area 212 is the one-point touch type, the processor 340 may verify a sub-area corresponding to one point among a plurality of sub-areas included in the frame area 212. Also, when the type of the touch to the frame area 212 is the one-point touch type, the processor 340 may determine a function menu associated with the verified sub-area among a plurality of function menus based on the first mapping information and may overlay the determined function menu on the current page. The first mapping information may include information about the plurality of function menus respectively associated with the plurality of sub-areas included in the frame area 212. For example, the frame area 212 may be divided into a first sub-area including an upper area and a lower area and a second sub-area including a left side area and a right side area. The first mapping information may include mapping information between the first sub-area and a first function menu and mapping information between the second sub-area and a second function menu. In this case, when one point of the first sub-area is touched, the processor 340 may overlay the first function menu on the current page. When one point of the second sub-area is touched, the processor 340 may overlay the second function menu on the current page. Each function menu may include a function menu icon.

According to an embodiment, the processor 340 may determine a display location of the verified function menu based on a location of the one point and may overlay the verified function menu on the determined location of the current page. For example, in the case where the first function menu (or the second function menu) is larger in size than a sub-area associated with the first function menu, the processor 340 may change a location where the first function menu is displayed, depending on a location of the one point.

According to an embodiment, when a touch type is a type in which a swipe follows after a touch to the frame area 212, the processor 340 may overlay a function menu corresponding to a direction of the swipe among the plurality of function menus on the current page. For example, when a touch to one point is made, the processor 340 may display summary information of the plurality of function menus; when a swipe follows seamlessly after the touch to the one point, the processor 340 may overlay a function menu corresponding to a direction of the swipe among the plurality of function menus on the current page. The second mapping information may include information of a plurality of function menus respectively associated with a plurality of swipe directions. Additionally or alternatively, when a swipe follows after a touch to one point, the processor 340 may execute a function menu corresponding to a direction of the swipe among the plurality of function menus.

According to various embodiments, the processor 340 may scroll the current page in a situation where the transparent area 211 and the frame area 212 are simultaneously touched. For example, when a touch of a swipe type to the transparent area 211 is sensed in a state where a touch of an external subject to the frame area 212 is sensed through the sensor circuit 310, the processor 340 may update and display the current page.

According to various embodiments, when a touch of a swipe type is made in a state where a menu list is displayed, the processor 340 may scroll the menu list. The processor 340 may scroll the menu list in another shape depending on a swipe direction. For example, when the event that a touch of a swipe type is made in an enumerated direction of the menu list in a state where the menu list is displayed is detected, the processor 340 may scroll the menu list. When the event that a touch of a swipe type is made in a direction perpendicular to the enumerated direction of the menu list in a state where the menu list is displayed is detected, the processor 340 may change the menu list by a specified unit (e.g., a page unit).

According to various embodiments, when a touch of a swipe type to the frame area 212 is sensed in a standby mode or a screen saver mode, the processor 340 may change information to be displayed on a screen depending on a swipe direction.

According to the above embodiment, the processor 340 may perform a page search operation (e.g., scroll, enlargement, reduction, or the like) based on a touch to the frame area 212 without a separate menu manipulation in the drawing mode, thereby improving convenience in page search markedly. The processor 340 may allow an area displayed in the display 320 in the drawing mode not to be reduced due to a menu, by hiding the menu usually in the drawing mode and displaying the menu when a touch to the frame area 212 is made.

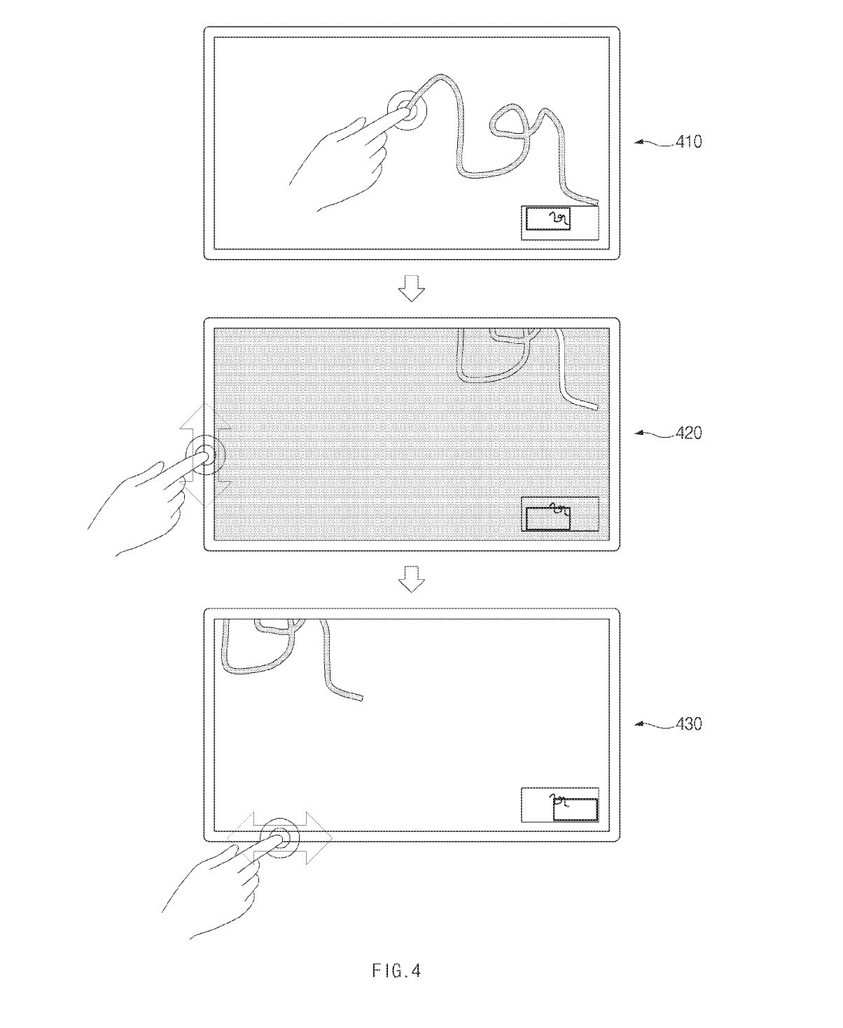

FIG. 4 illustrates UI screens associated with a process of performing a scroll operation based on a swipe, according to an embodiment.

Referring to FIG. 4, in screen 410, the processor 340 may display a current page of all pages in the display 320 in the drawing mode. Also, when a touch of an external subject to the current page is sensed, the processor 340 may perform a drawing function corresponding to the touch with regard to a point of the current page, at which the touch is made. The drawing mode may include, for example, a mode (e.g., an electronic board mode) supporting the drawing function. The drawing function may include a function of drawing a picture, writing a letter, etc. along user's touch.

In screen 420, when a touch of a swipe type is made in a vertical direction (top 4 bottom or bottom 4 top) in a left side area or a right side area of the frame area 212, the processor 340 may scroll the current page in the vertical direction. For example, when a touch of a swipe type is made in the left side area of the frame area 212 in a direction from the top to the bottom, the processor 340 may scroll the current page in a direction from the top to the bottom. As another example, when a touch of a swipe type is made in the left side area of the frame area 212 in a direction from the bottom to the top, the processor 340 may scroll the current page in a direction from the bottom to the top. In screen 420, the processor 340 may perform a scroll function when the area corresponding to the touch of the swipe type is smaller than a specified area.

In screen 430, when a touch of a swipe type is made in an upper area or a lower area of the frame area 212 in a horizontal direction (left 4 right or right 4 left), the processor 340 may scroll the current page in the horizontal direction. For example, when a touch of a swipe type is made in the lower area of the frame area 212 in a direction from the left to the right, the processor 340 may scroll the current page in a direction from the left to the right. As another example, when a touch of a swipe type is made in the lower area of the frame area 212 in a direction from the right to the left, the processor 340 may scroll the current page in a direction from the right to the left. In screen 430, the processor 340 may perform a scroll function when the area corresponding to the touch of the swipe type is smaller than a specified area.

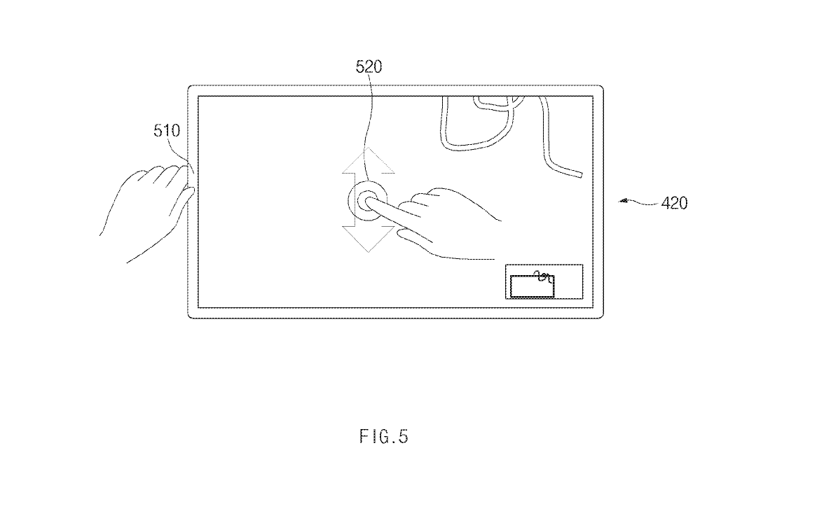

FIG. 5 illustrates an UI screen associated with a page scroll process corresponding to a multi-touch, according to an embodiment.

Referring to FIG. 5, in screen 420, in a situation where a transparent area 211 and the frame area 212 are simultaneously touched (510 and 520), a processor (e.g., 340 of FIG. 3) may scroll a current page so as to correspond to a swipe direction of a transparent area (e.g., 211 of FIG. 2). For example, when a swipe to the transparent area 211 is sensed in a state where a touch of an external subject to a frame area (e.g., 211 of FIG. 2) is sensed through a sensor circuit (e.g., 310 of FIG. 3), the processor 340 may scroll a current page depending on a direction of the sensed swipe.

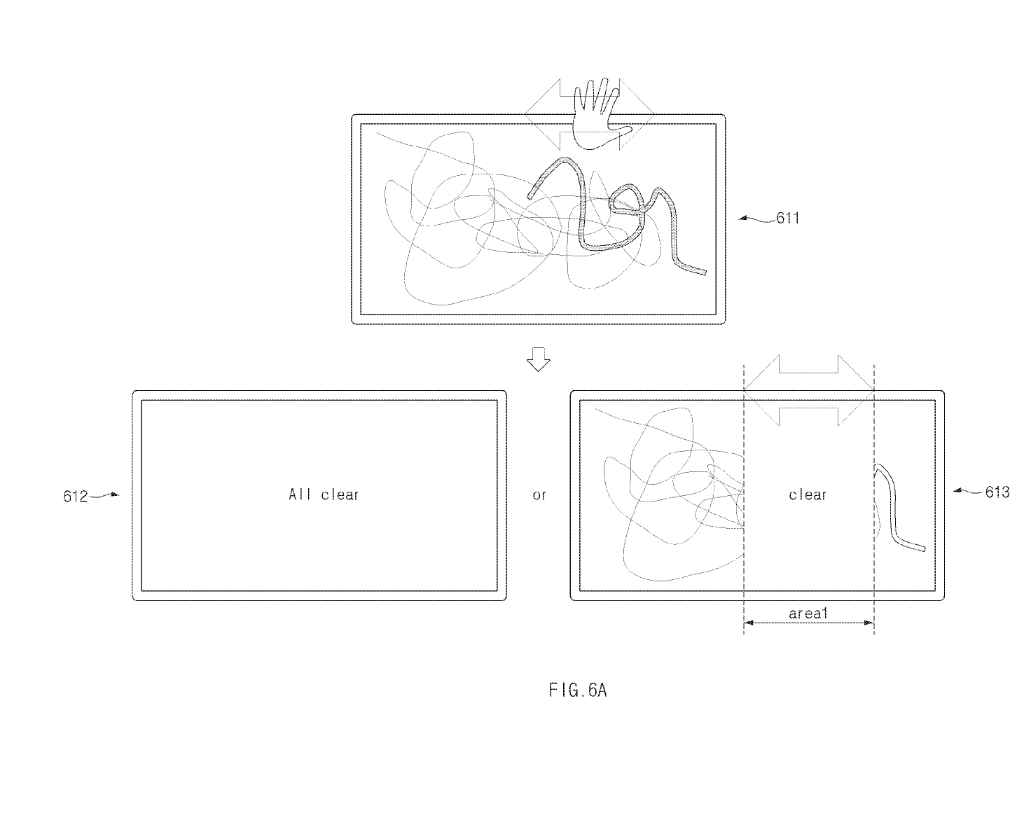

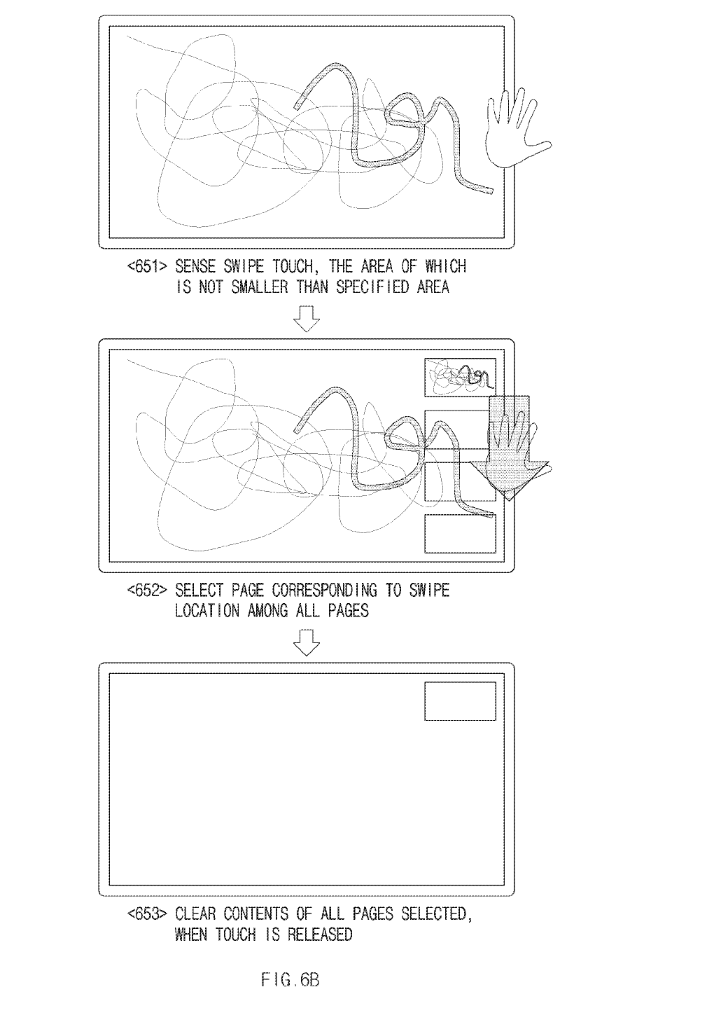

FIGS. 6A and 6B illustrate UI screens associated with a process of performing a clear function, according to an embodiment.

Referring to FIGS. 6A and 6B, according to an embodiment, when a touch of a swipe type is made, a processor (e.g., 340 of FIG. 3) may verify a touch area of an external subject. Also, when the touch area is the specified area or larger, a processor (e.g., 340 of FIG. 3) may perform a clear function on a current page or at least a portion of all pages depending on a direction of the swipe. The specified area may be set to such an extent as to distinguish a finger touch and a palm touch.

Referring to FIG. 6A, in screen 611, the processor 340 may determine that a swipe-type touch (e.g., a swipe manipulation by a palm), the area of which is a specified area or larger, is made in an upper area of a frame area (e.g., 212 of FIG. 2) in a first direction. The first direction may be, for example, a direction which is opposite (e.g., perpendicular) to a direction in which all pages are enumerated. When the enumerated direction of all the pages is a vertical direction, the first direction may be a horizontal direction.

In screen 612, when a touch of a swipe type to in the frame area 212 is made in the first direction, the processor 340 may clear the contents of the whole area of the current page. Alternatively, in screen 613, when a touch of a swipe type to the frame area 212 is made in the first direction, the processor 340 may clear an area area1 of the current page, which corresponds to a location of the swipe.

Referring to FIG. 6B, in screen 651, the processor 340 may determine that a swipe-type touch (e.g., a swipe manipulation by a palm), the area of which is a specified area or larger, is made in a right side area of the frame area 212 in a second direction. The second direction may be, for example, a direction in which all pages are enumerated.

In screen 652, when a direction of the swipe is the second direction, the processor 340 may select a page corresponding to a location of the swipe among all the pages.

In screen 653, when a touch, the area of which is a specified area or larger, is released, the processor 340 may clear the contents of all the pages selected.

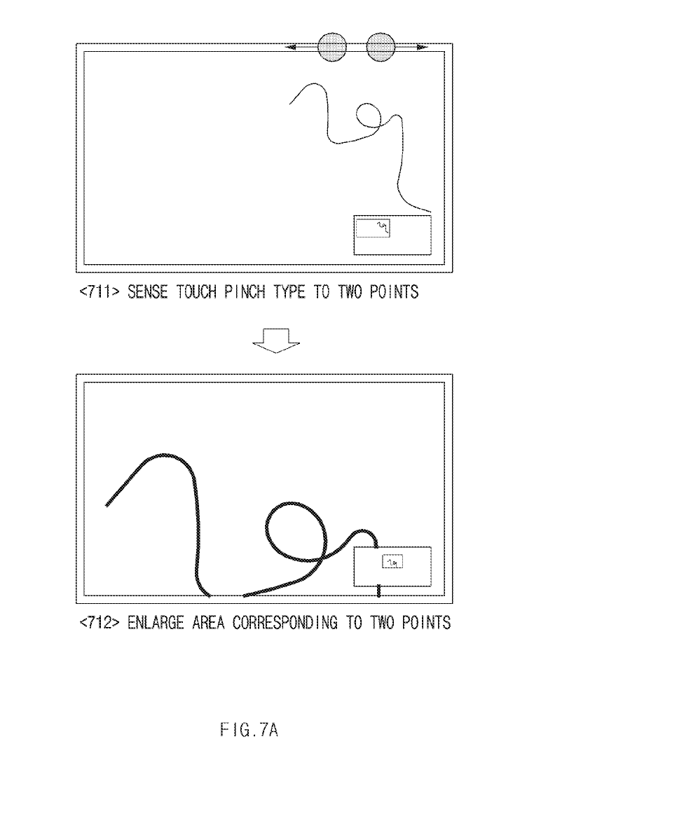

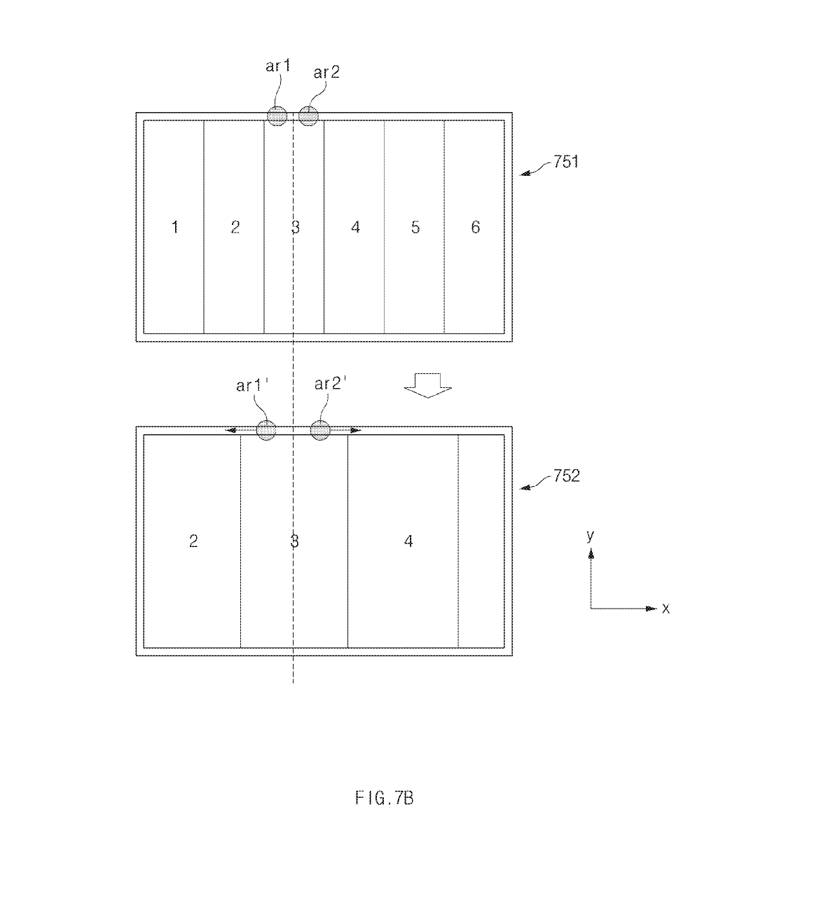

FIGS. 7A and 7B are views for describing a process of enlarging a page based on a touch of a pinch type, according to an embodiment.

Referring to FIG. 7A, in screen 711, after a touch to two points of a frame area (e.g., 212 of FIG. 2) is made, when an increase in a distance between the two points is sensed through a sensor circuit (e.g., 310 of FIG. 3), a processor (e.g., 340 of FIG. 3) may determine that a touch type is a pinch type.

In screen 712, when a touch of a pinch type is made, the processor 340 may enlarge an area corresponding to the two points of the pinch-type touch.

Referring to FIG. 7B, in screen 751, when two points ar1 and ar2 of the frame area 212 are touched, the processor 340 may determine a location of an imaginary line passing through a point centered between the two points. In the case where the touch of the pinch type is made in a horizontal direction (an x-direction), the imaginary line may be a line which passes through the center between the two points and is parallel to a pixel column of the display 320. In the case where the touch of the pinch type is made in a vertical direction (a y-direction), the imaginary line may be a line which passes through the center between the two points and is parallel to a pixel row of the display 320.

In screen 752, when a distance between the two points ar1 and ar2, which are touched, of the frame area 212 increases (ar1′ and ar2′), the processor 340 may enlarge a current page with respect to a center pixel located on the imaginary line among pixels, as much as a magnification corresponding to the distance between the two points.

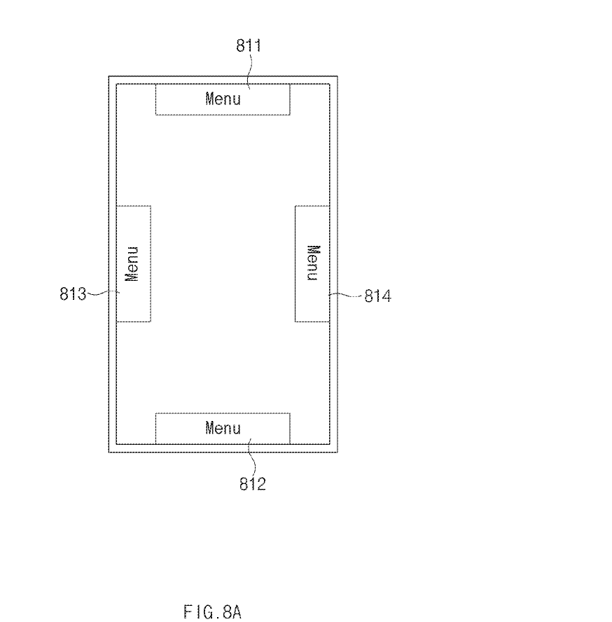

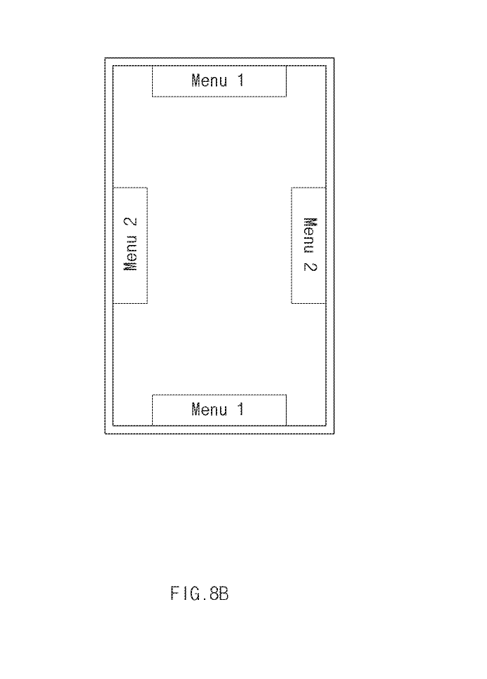

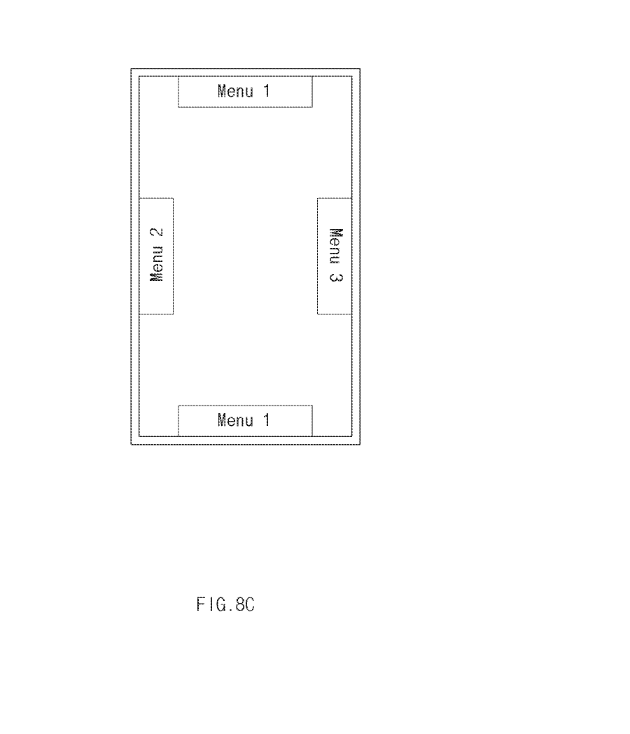

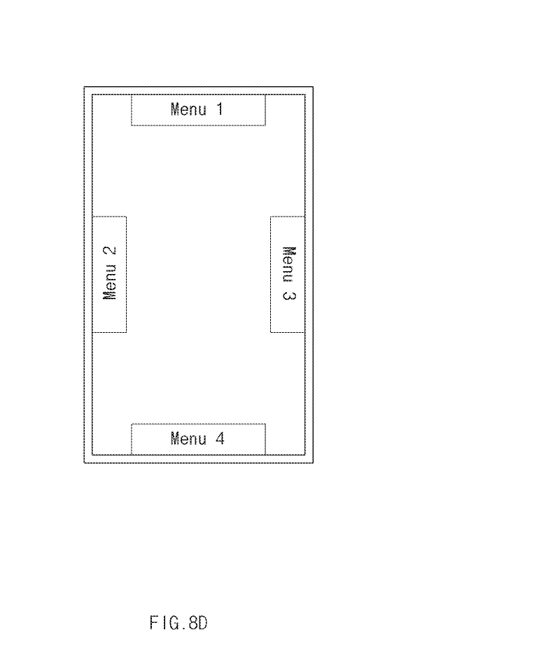

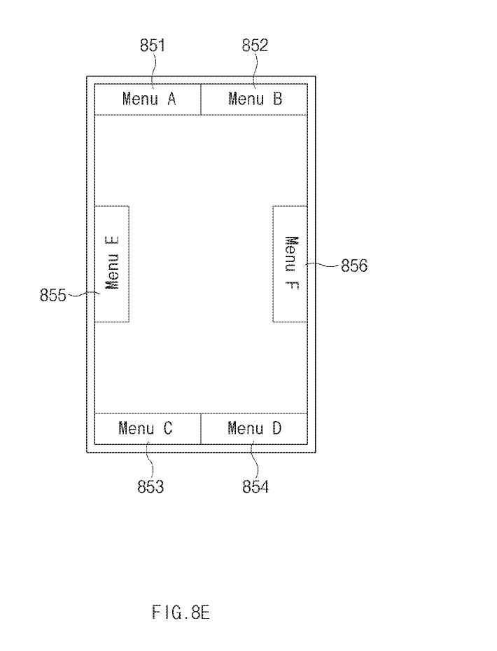

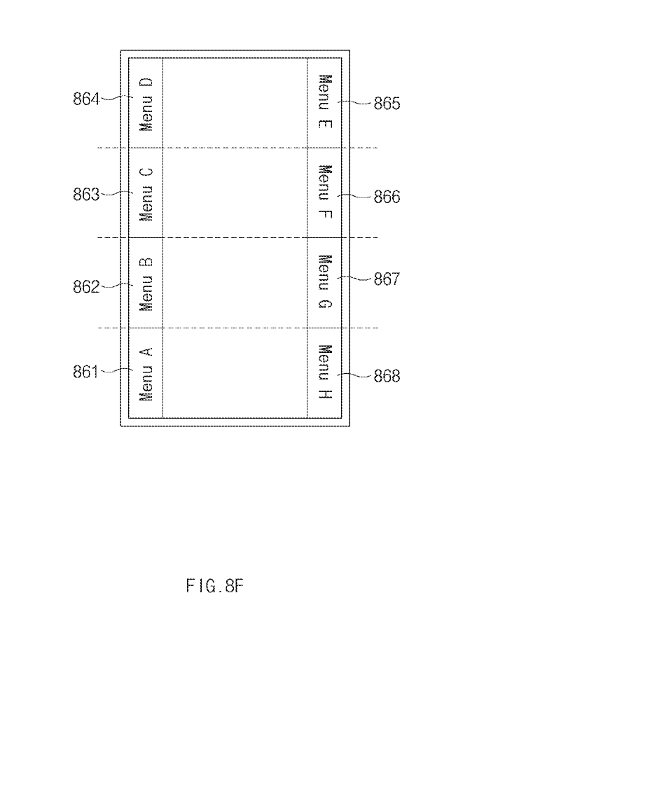

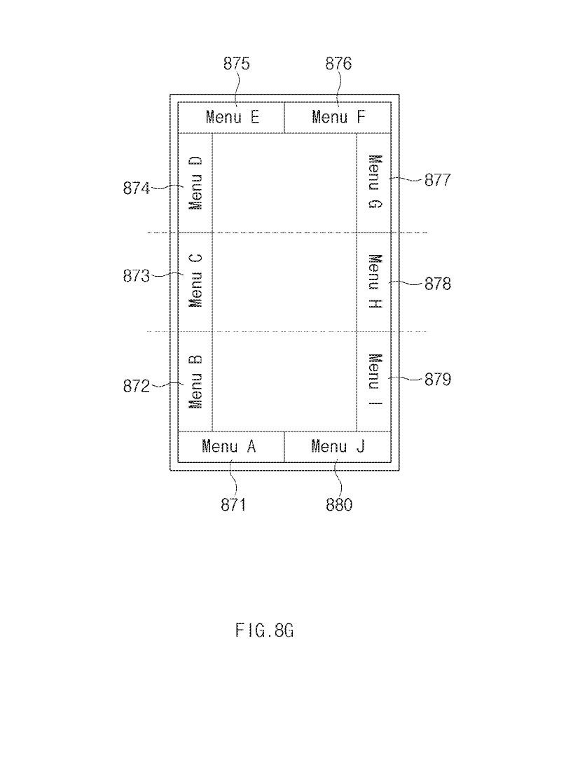

FIGS. 8A to 8G are views for describing at least one function menu associated with a plurality of sub-areas included in a frame area, according to an embodiment.

Referring to FIG. 8A, when one function menu (or one function menu bar) exists, a processor (e.g., 340 of FIG. 3) may associate one function menu with an upper area 811, a lower area 812, a left side area 813, and a right side area 814 of a frame area (e.g., 212 of FIG. 2). When the upper area 811, the lower area 812, the left side area 813, or the right side area 814 is touched, the processor 340 may display one function menu “Menu”. When the function menu is touched in a state where the function menu is displayed, the processor 340 may execute the function menu corresponding to the touched location.

Referring to FIG. 8B, when two function menus exist and the upper area or the lower area of the frame area 212 is touched, the processor 340 may display a first function menu menu1. Also, when the left side area or the right side area of the frame area 212 is touched, the processor 340 may display a second function menu menu2. When the first function menu menu1 or the second function menu menu2 is touched in a state where the first function menu menu1 or the second function menu menu2 is displayed, the processor 340 may execute the function menu corresponding to the touched location.

Referring to FIG. 8C, when three function menus exist and the upper area or the lower area of the frame area 212 is touched, the processor 340 may display the first function menu menu1. Also, when the left side area of the frame area 212 is touched, the processor 340 may display the second function menu menu2; when the right side area of the frame area 212 is touched, the processor 340 may display a third function menu menu3. When one of the first function menu menu1, the second function menu menu2, and the third function menu menu3 is touched in a state where the first function menu menu1, the second function menu menu2, or the third function menu menu3 is displayed, the processor 340 may execute a function menu corresponding to the touched location.

Referring to FIG. 8D, when four function menus exist, the processor 340 may display the first function menu menu1 in the upper area of the frame area 212. Also, when the left side area of the frame area 212 is touched, the processor 340 may display the second function menu menu2; when the right side area of the frame area 212 is touched, the processor 340 may display the third function menu menu3; when the lower area of the frame area 212 is touched, the processor 340 may display a fourth function menu menu4.

Referring to FIG. 8E, when six function menus exist, the processor 340 may divide the upper area of the frame area 212 into a left upper area 851 and a right upper area 852 and may associate a first function menu MenuA and a second function menu MenuB with the left upper area 851 and the right upper area 852, respectively. Also, the processor 340 may divide the lower area of the frame area 212 into a left lower area 853 and a right lower area 854 and may associate a third function menu MenuC and a fourth function menu MenuD with the left lower area 853 and the right lower area 854, respectively. Also, the processor 340 may associate a left side area 855 with a fifth function menu MenuE and may associate a right side area 856 with a sixth function menu MenuF. The processor 340 may display the first function menu MenuA when the left upper area 851 is touched, may display the second function menu MenuB when the right upper area 852 is touched, and may display the third function menu MenuC when the left lower area 853 is touched. The processor 340 may display the fourth function menu MenuD when the right lower area 854 is touched, may display the fifth function menu MenuE when the left side area 855 is touched, and may display the sixth function menu MenuF when the right side area 856 is touched.

Referring to FIG. 8F, the processor 340 may assign a plurality of function menus only to the left side area and the right side area of the frame area 212. For example, when eight function menus exist, the processor 340 may divide the left side area of the frame area 212 into first to fourth left side areas 861 to 864 and may associate first to fourth function menus MenuA to MenuD with the first to fourth left side areas 861 to 864, respectively. Also, the processor 340 may divide the right side area of the frame area 212 into fifth to eighth right side areas 865 to 868 and may associate fifth to eighth function menus MenuE to MenuH with the fifth to eighth right side areas 865 to 868, respectively. When the first to fourth left side areas 861 to 864 are respectively touched, the processor 340 may respectively display the first to fourth function menus MenuA to MenuD associated with the first to fourth left side areas 861 to 864; when the fifth to eighth right side areas 865 to 868 are respectively touched, the processor 340 may respectively display the fifth to eighth function menus MenuE to MenuH associated with the fifth to eighth right side areas 865 to 868.

Referring to FIG. 8G, when ten function menus exist, the processor 340 may display each of the left side area and the right side area of the frame area 212 into three areas. Also, the processor 340 may divide each of an upper area and a lower area into two areas. In this case, the processor 340 may associate first to tenth sub-areas 871 to 880 with first to tenth function menus MenuA to MenuJ, respectively. When the first to tenth sub-areas 871 to 880 are respectively touched, the processor 340 may respectively display the first to tenth function menus MenuA to MenuJ associated with the first to tenth sub-areas 871 to 880.

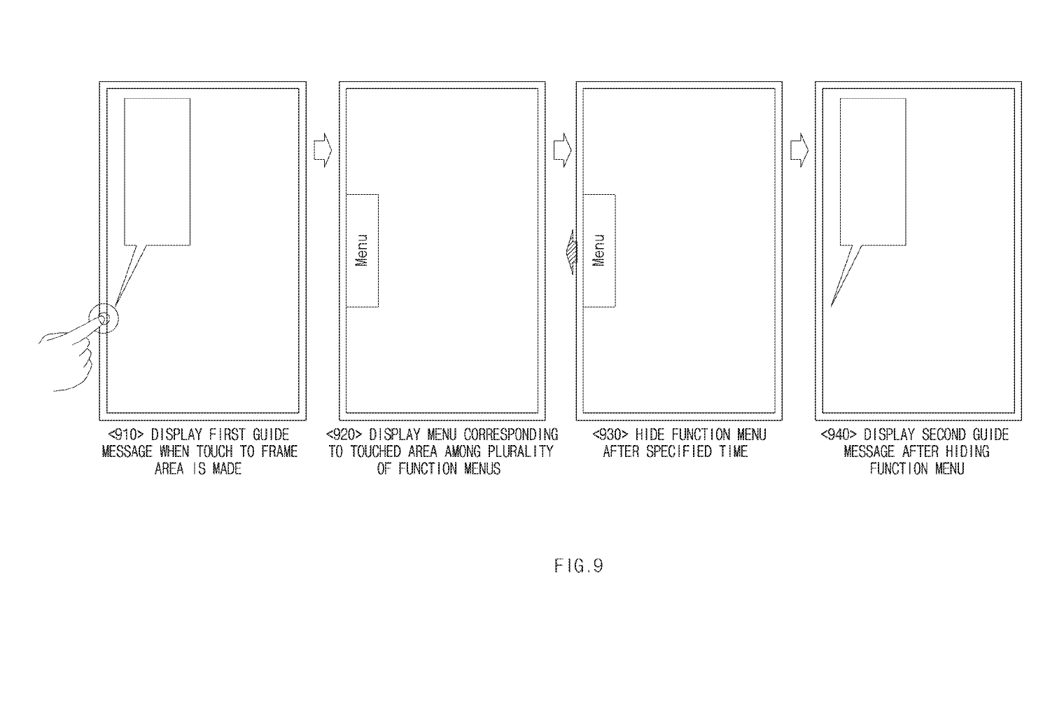

FIG. 9 is a diagram for describing a process of displaying a function menu based on a touch, according to an embodiment.

Referring to FIG. 9, in screen 910, when a touch to a left side area of a frame area is made, a processor (e.g., 340 of FIG. 3) may output a first guide message. The first guide message may include a sentence guiding that a function menu will be displayed depending on a touch. The processor 340 may verify a function menu associated with the touched left side area.

In screen 920, the processor 340 may overlay and display a function menu associated with the touched left side area among a plurality of function menus on a current page. In screen 920, the processor 340 may display a function menu (or a function menu icon) corresponding to a location of user's touch such that the function menu is displayed at a fixed location. For example, when the left side area is touched, the processor 340 may display a function menu associated with the left side area such that the function menu is displayed at a fixed location of the left side area.

In screen 930, the processor 340 may again hide the displayed function menu when a specified time elapses without manipulating the displayed function menu.

In screen 940, the processor 340 may display a second guide message after hiding the function menu. The second guide message may include a sentence providing notification that a function menu will be displayed when a touch of an external subject is made.

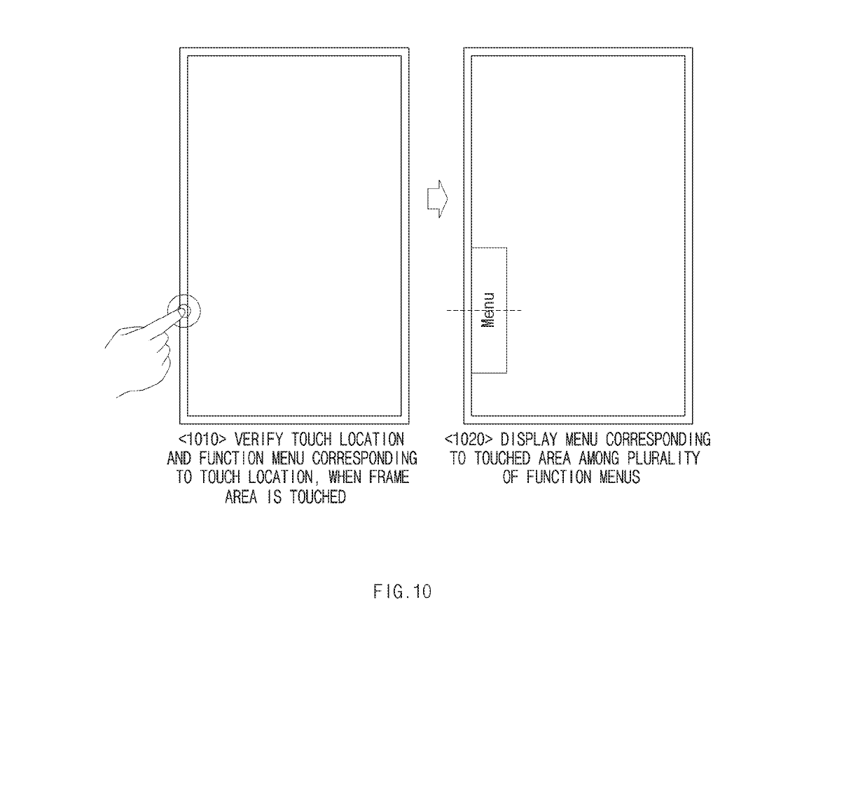

FIG. 10 is a view for describing a method for displaying a function menu corresponding to a touch location, according to an embodiment.

Referring to FIG. 10, in screen 1010, when a frame area (e.g., 212 of FIG. 2) is touched, a processor (e.g., 340 of FIG. 3) may verify a touch location (e.g., a touch coordinate value) and a function menu associated with the touch location. The processor 340 may verify a location of a pixel closest to a touch point.

In screen 1020, the processor 340 may display the function menu corresponding to the touch location such that the pixel closest to the touch point is located at the center of the function menu. According to the above embodiment, as a function menu is displayed to be close to a touch point, a user may verify the function menu without a movement of his/her eyes after the touch.

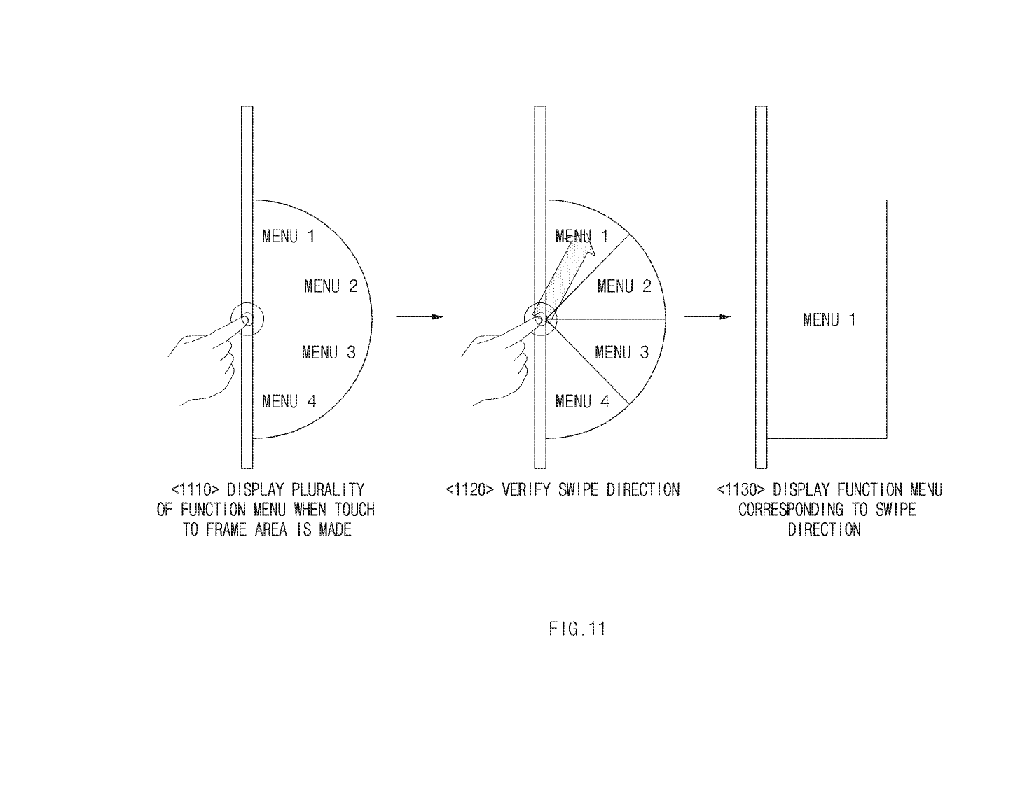

FIG. 11 is a view for describing a method for displaying a function menu based on a swipe direction, according to an embodiment.

Referring to FIG. 11, in screen 1110, when one point of a frame area (e.g., 212 of FIG. 2) is touched during a specified time or more, a processor (e.g., 340 of FIG. 3) may display summary information of a plurality of function menus. The processor 340 may display the summary information of the plurality of function menus with respect to the center of the function menu.

In screen 1120, when a swipe follows after the touch to the one point, the processor 340 may verify a direction of the swipe.

In screen 1130, the processor 340 may verify a function menu corresponding to the swipe direction among the plurality of function menus based on the second mapping information, and may overlay the verified function menu on a current page. Additionally or alternatively, the processor 340 may immediately execute the verified function menu.

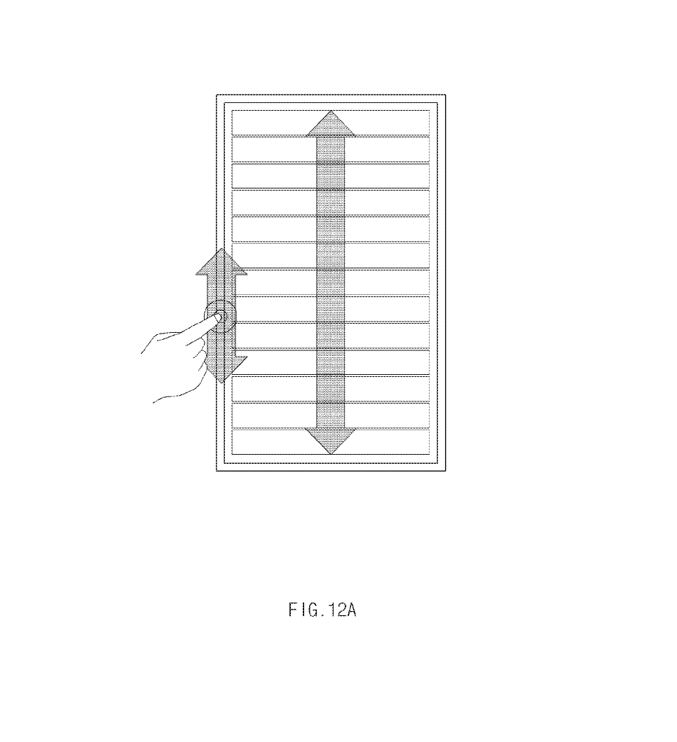

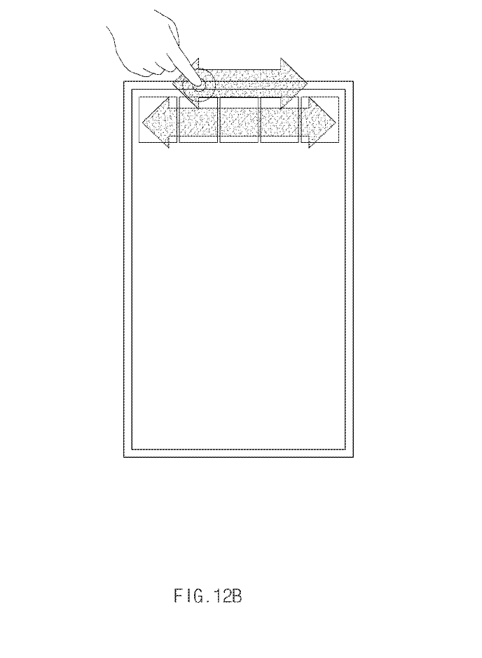

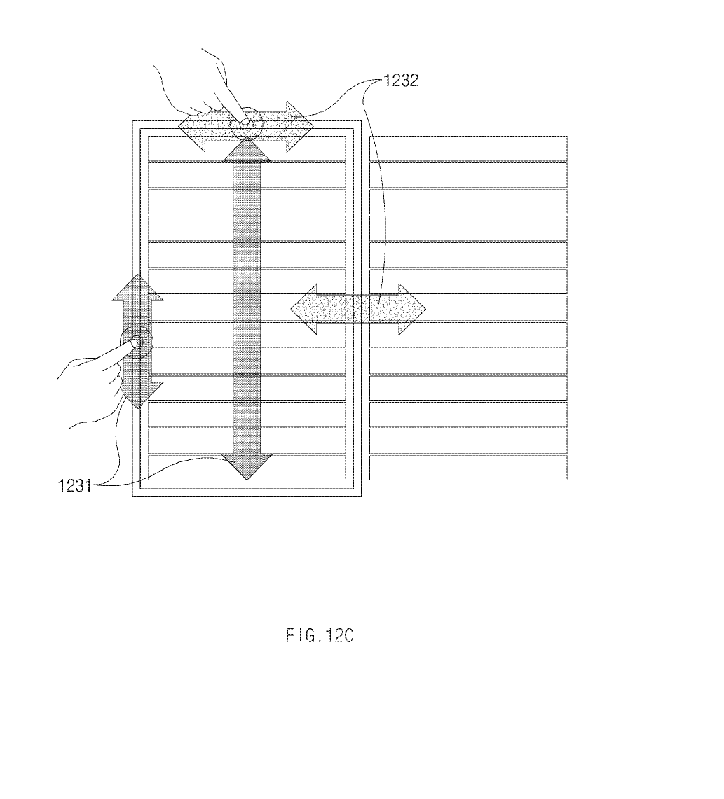

FIGS. 12A and 12B are views for describing a menu scroll method according to an embodiment.

Referring to FIG. 12A, according to an embodiment, a processor (e.g., 340 of FIG. 3) may sense a swipe of a vertical direction associated with a frame area (e.g., 212 of FIG. 2) in a state where a menu list (or an icon list) is vertically enumerated. When the swipe of the vertical direction is sensed, the processor 340 may scroll the menu list in the vertical direction.

Referring to FIG. 12B, according to an embodiment, the processor 340 may sense a swipe of a horizontal direction associated with the frame area 212 in a state where a menu list (or an icon list) is horizontally enumerated. When the swipe of the horizontal direction is sensed, the processor 340 may scroll the menu list in the horizontal direction.

In FIGS. 12A and 12B, when a menu list is scrolled in a state where one menu of a menu list is selected, the processor 340 may change and specify the selected menu.

According to the above embodiment, the processor 340 may provide an interface associated with scrolling a menu list, specifying a menu, or the like based on manipulating a touch to the frame area 212.

FIG. 12C is a view for describing a method for scrolling a menu based on a swipe direction, according to an embodiment.

Referring to FIG. 12C, according to an embodiment, when the event that a touch of a swipe type is made in an enumerated direction of a menu list in a state where the menu list is displayed is detected, the processor 340 may scroll the menu list. When the event that a touch of a swipe type is made in a direction perpendicular to the enumerated direction of the menu list in a state where the menu list is displayed is detected, the processor 340 may change the menu list by a specified unit (e.g., a page unit). For example, in a state where the menu list is vertically enumerated, when a swipe-type touch in a vertical direction is sensed, the processor 340 may scroll the menu list vertically (refer to 1231). As another example, in a state where the menu list is vertically enumerated, when a swipe-type touch in a horizontal direction is sensed, the processor 340 may scroll the menu list by the specified unit (refer to 1232).

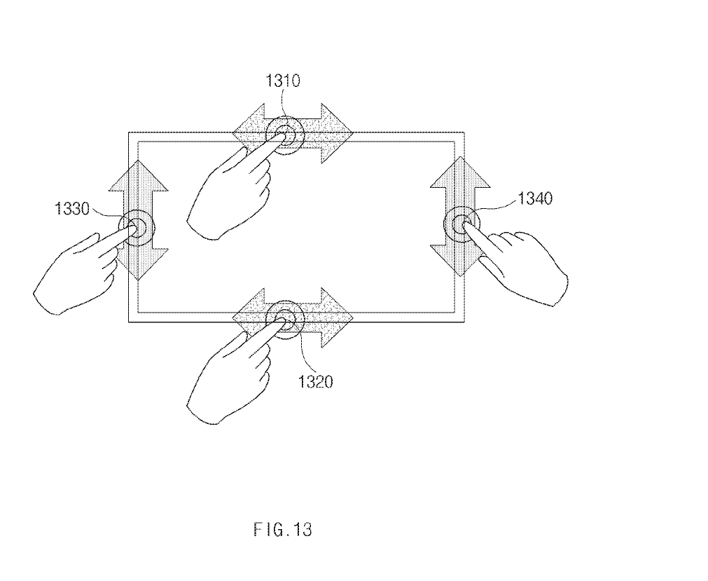

FIG. 13 is a view for describing a function executing method for each swipe direction according to an embodiment.

Referring to FIG. 13, according to an embodiment, a processor (e.g., 340 of FIG. 3) may respectively assign different functions to an upper area 1310, a lower area 1320, a left side area 1330, and a right side area 1340 of the frame area 212; when one of the upper area 1310, the lower area 1320, the left side area 1330, and the right side area 1340 is touched, the processor 340 may perform a function associated with the touched area. For example, when a swipe-type touch to the upper area 1310 is sensed, the processor 340 may change an external input (e.g., may change an input interface). When a swipe-type touch to the lower area 1320 is sensed, depending on a direction of the swipe, the processor 340 may specify a menu list or may change and specify a menu list. When a swipe-type touch to the left side area 1330 is sensed, the processor 340 may control a volume value. When a swipe-type touch to the right side area 1340 is sensed, the processor 340 may change a channel.

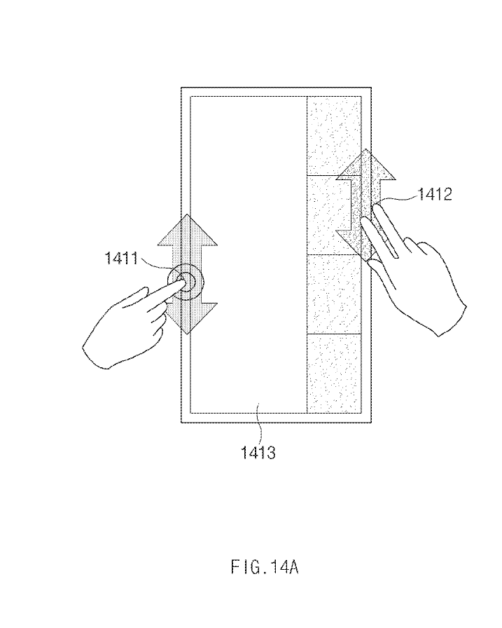

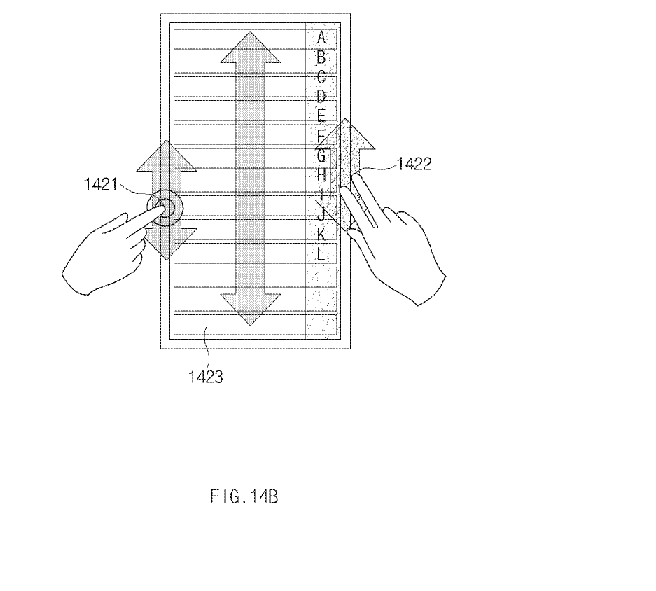

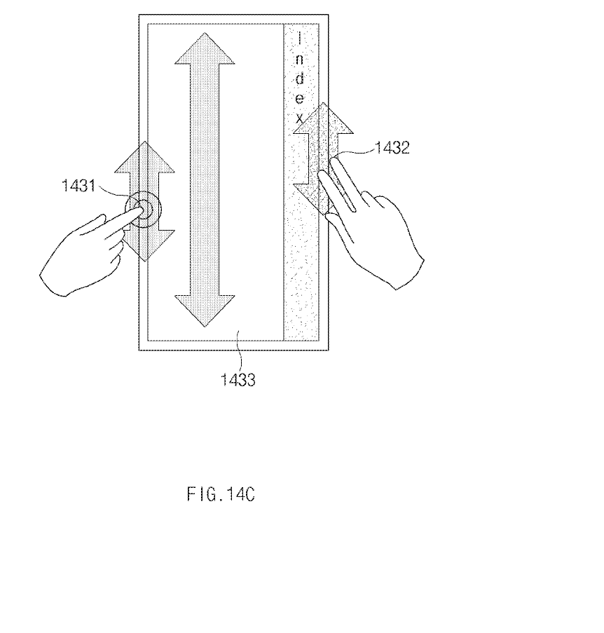

FIGS. 14A to 14C are views for describing various scroll functions based on a multi-touch, according to an embodiment.

Referring to FIGS. 14A to 14C, according to an embodiment, a processor (e.g., 340 of FIG. 3) may provide different scroll functions when sensing a single touch (e.g., a one-finger touch) of a swipe type and when sensing a multi-touch (e.g., a two-finger touch) of a swipe type. The single touch of the swipe type may be, for example, a touch in which one point of a frame area (e.g., 212 of FIG. 2) is touched and then is swiped. The multi-touch of the swipe type may be, for example, a touch in which two points of the frame area are touched and then are swiped in the same direction.

Referring to FIG. 14A, when sensing a single touch of a swipe type in a state where a white board 1413 is displayed (e.g., in a drawing mode) (refer to 1411 of FIG. 14A), the processor 340 may provide a function of scrolling the white board 1413 depending on a swipe direction. When sensing a multi-touch of a swipe type in a state where the white board 1413 is displayed (refer to 1412 of FIG. 14A), the processor 340 may provide a function of scrolling the white board 1413 for each page (e.g., a function of moving a page) depending on a swipe direction.

Referring to FIG. 14B, when sensing a single touch of a swipe type in a state where contacts with phone numbers 1423 are displayed (refer to 1421 of FIG. 14B), the processor 340 may provide a function of scrolling the contacts with phone numbers 1423 depending on a swipe direction. Referring to FIG. 14B, when sensing a single touch of a swipe type in a state where contacts with phone numbers 1423 are displayed (refer to 1422 of FIG. 14B), the processor 340 may provide a function of scrolling the contacts with phone numbers 1423 depending on a swipe direction.

Referring to FIG. 14C, when sensing a single touch of a swipe type in a state where an e-book 1433 is displayed (refer to 1431 of FIG. 14C), the processor 340 may provide a function of moving a page of the e-book 1433 depending on a swipe direction. When sensing a multi-touch of a swipe type in a state where the e-book 1433 is displayed (refer to 1432 of FIG. 14C), the processor 340 may provide a function of moving a list or a bookmark of the e-book 1433 depending on a swipe direction.

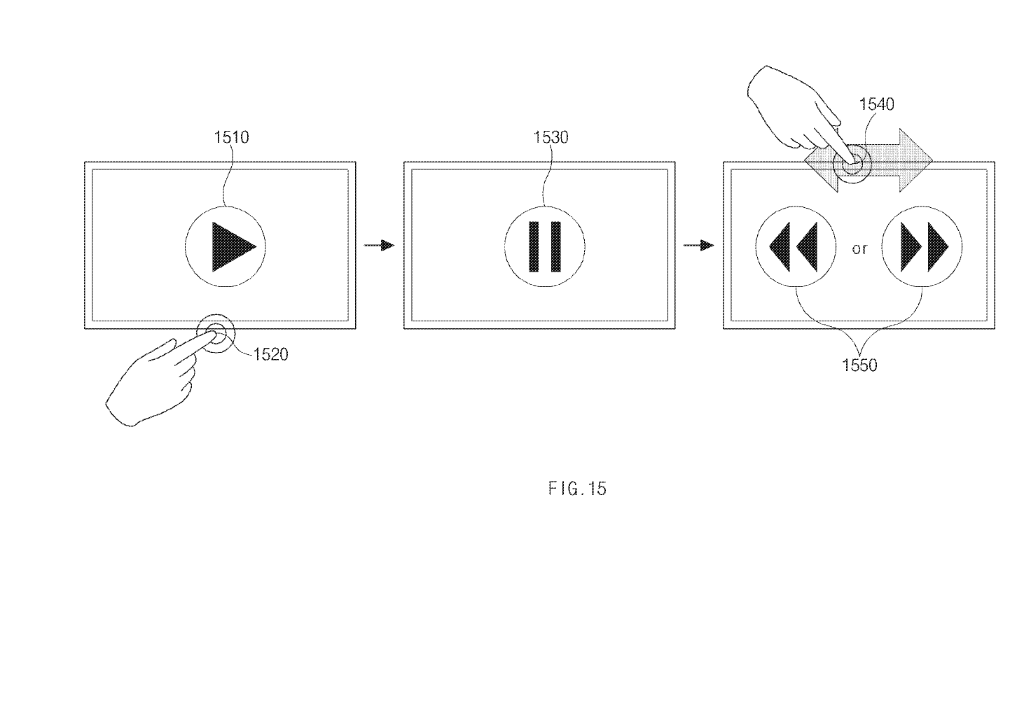

FIG. 15 is a view for describing a method for executing a function based on a touch of a swipe type while playing content, according to an embodiment.

Referring to FIG. 15, according to an embodiment, a processor (e.g., 340 of FIG. 3) may sense a touch 1520 to one point of a frame area (e.g., 212 of FIG. 2) while playing content (refer to 1510 of FIG. 15). When sensing the touch 1520 to the one point of the frame area 212 while playing the content, the processor 340 may provide a function of pausing the playback of the content (refer to 1530 of FIG. 15).

When sensing a touch 1540 of a swipe type to the frame area 212 while playing content, the processor 340 may provide a rewind function or a fast forward function depending on a swipe direction.

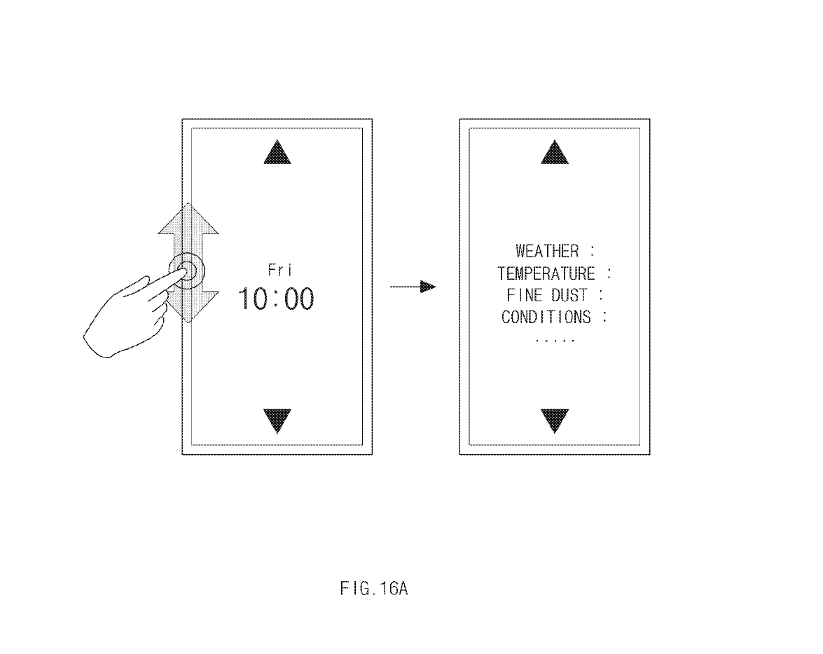

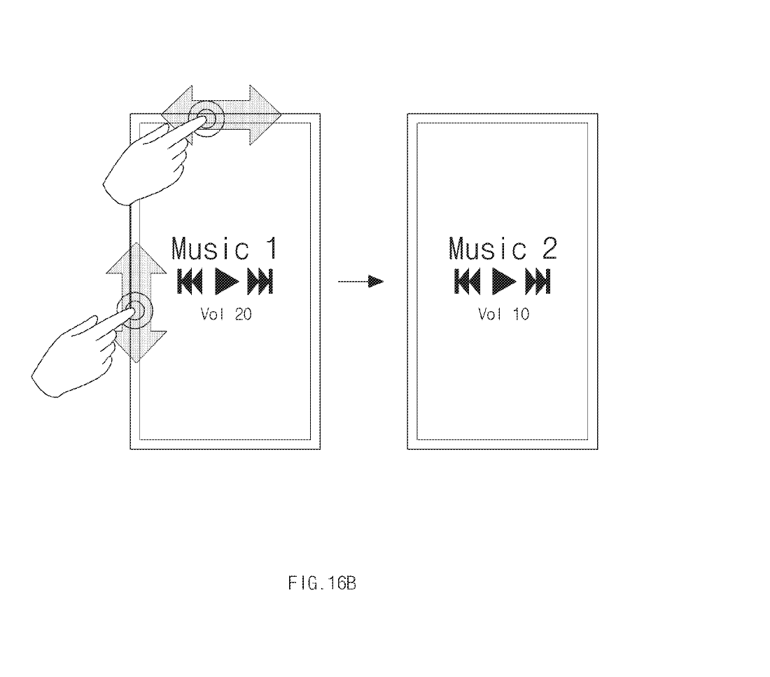

FIGS. 16A and 16B are views for describing how to execute a function based on a touch of a frame area in a standby mode (or a screen saver mode), according to an embodiment.

According to an embodiment, when sensing a touch of a swipe type to a frame area (e.g., 212 of FIG. 2) in a standby mode or a screen saver display mode, the processor 340 may change information to be displayed on a screen depending on a swipe direction. For example, referring to FIG. 16A, when sensing a touch of a swipe type in an upper/lower direction while displaying time information in the standby mode, the processor 340 may display weather information.

Referring to FIG. 16B, when sensing a touch of a swipe type to the frame area 212 while playing music in the standby mode, the processor 340 may provide a music selection function, a play/stop function, or a volume control function depending on a swipe direction.

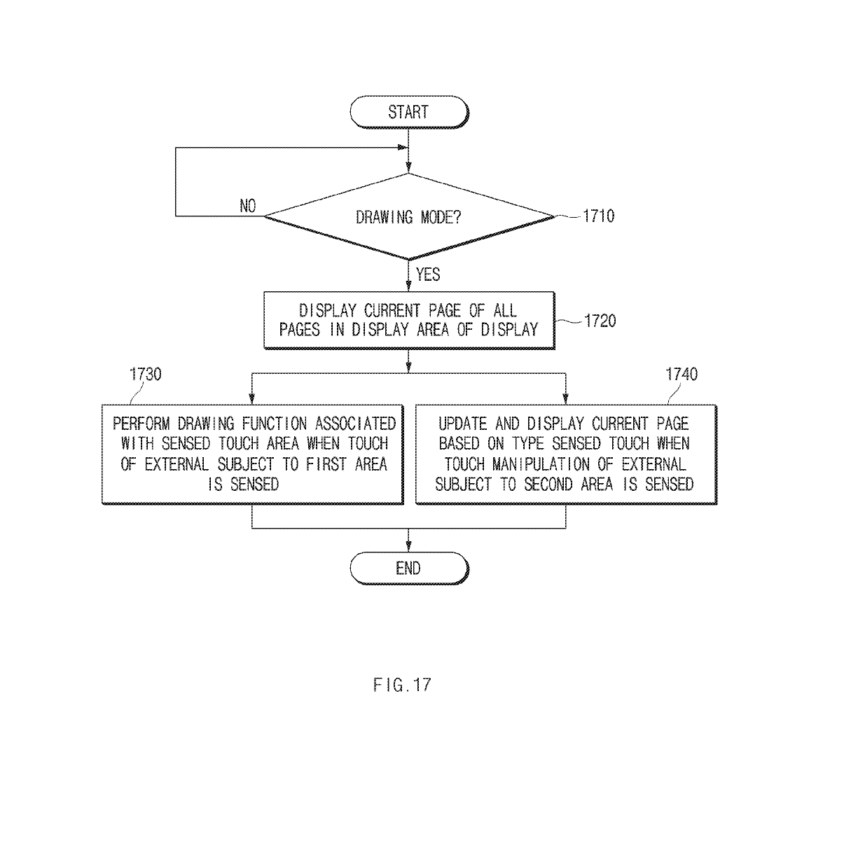

FIG. 17 is a flowchart illustrating a method for executing a function based on a touch sensing area, according to an embodiment.

Referring to FIG. 17, in operation 1710, a processor (e.g., 340 of FIG. 3) may determine whether a current mode is a drawing mode. The drawing mode may include, for example, a mode (e.g., an electronic board mode) to support a drawing function. The drawing function may include a function of drawing a picture, writing a letter, and the like along user's touch.

When the current mode is the drawing mode, in operation 1720, the processor 340 may display a current page of all pages in the display 320. The current page may be, for example, a default page or a lastly selected page.

In operation 1730, when a touch of an external subject to the displaying area 211 is sensed through the sensor circuit 310, the processor 340 may perform a drawing function associated with a touch sensing area in which the touch is sensed.

In operation 1740, when a touch of a swipe type to the non-displaying area 212 is sensed through the sensor circuit 310, the processor 340 may determine a type of the touch and may update and display the current page based on the determined touch type.

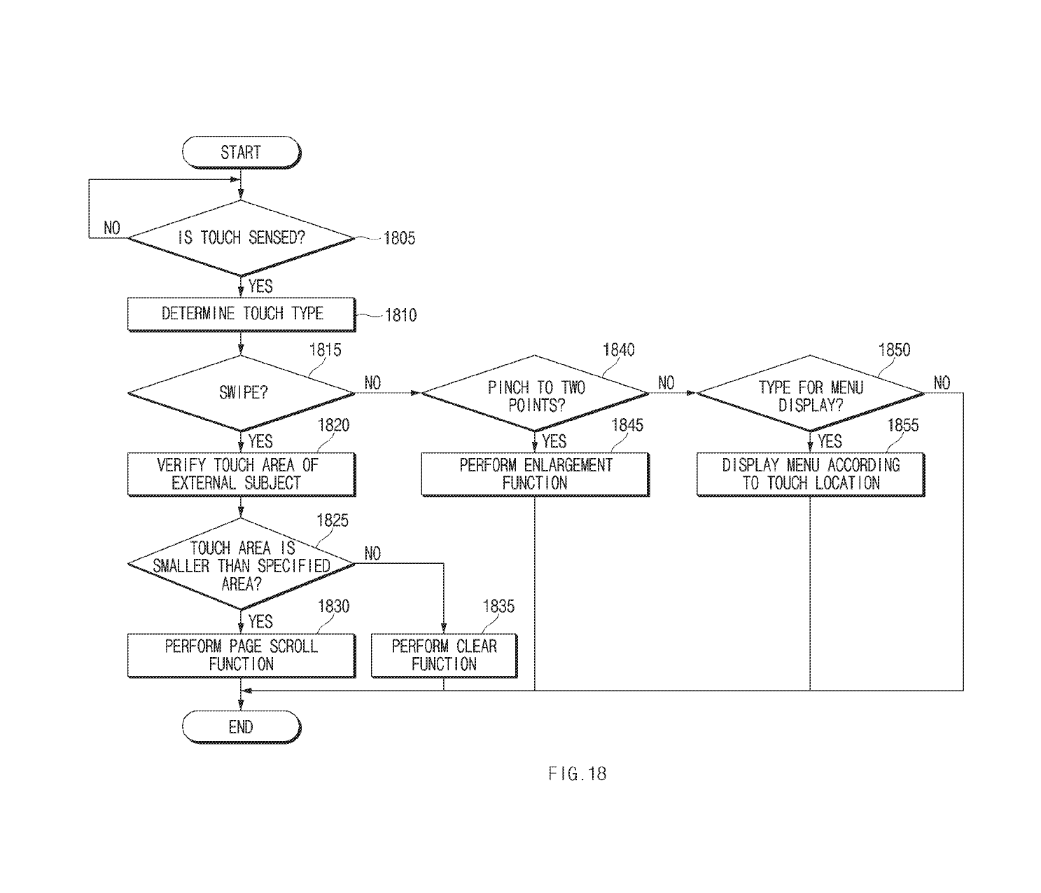

FIG. 18 is a flowchart illustrating a method for executing a function based on a touch type, according to an embodiment.

Referring to FIG. 18, in operation 1805, a processor (e.g., 340 of FIG. 3) may determine whether a touch to a frame area (e.g., 212 of FIG. 2) is made.

When the touch to the frame area 212 is sensed, in operation 1810, the processor 340 may determine a type of the touch.

When it is determined in operation 1815 that the determined touch type is a swipe type, in operation 1820, the processor 340 may verify the area of the sensed touch.

In operation 1825, the processor 340 may determine whether the verified touch area is smaller than a specified area. The specified area may be set to such an extent as to distinguish a finger touch and a palm touch.

When the verified touch area is smaller than the specified area, in operation 1830, the processor 340 may perform a page scroll function corresponding to a swipe direction.

When the verified touch area is not smaller than the specified area, in operation 1835, the processor 340 may perform a function of performing a clear operation along the swipe direction.

When it is determined in operation 1840 that the determined touch type is a pinch type, in operation 1845, the processor 340 may perform an enlargement function depending on the touch of the pinch type.

When it is determined in operation 1850 that the determined touch type is a type for displaying a menu, in operation 1855, the processor 340 may display a menu corresponding to a touch location.

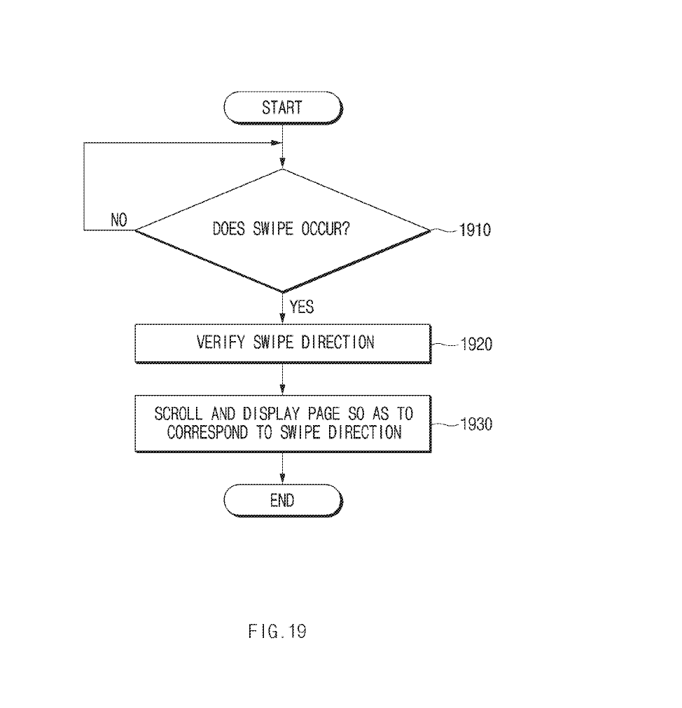

FIG. 19 is a flowchart illustrating a method for scrolling a page based on a swipe, according to an embodiment.

Referring to FIG. 19, when it is determined in operation 1910 that a touch of a swipe type to a frame area (e.g., 212 of FIG. 2) is made, in operation 1920, a processor (e.g., 340 of FIG. 3) may verify a swipe direction.

In operation 1930, the processor 340 may scroll and display a current page so as to correspond to the swipe direction.

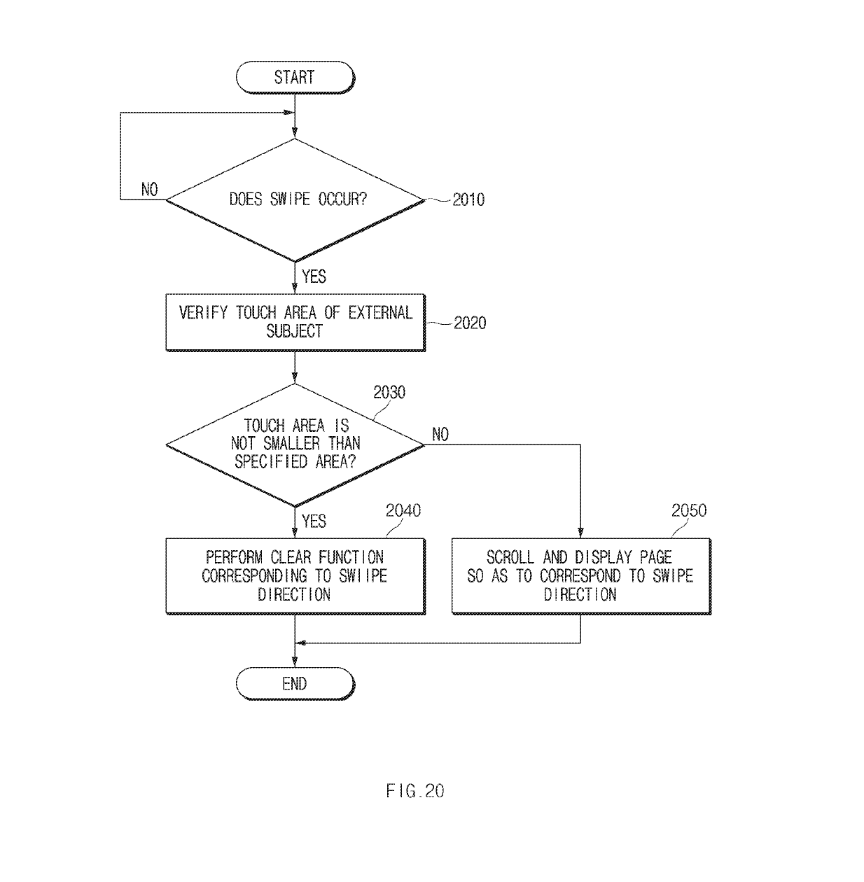

FIG. 20 is a flowchart illustrating a method for executing a scroll function and a clear function, according to an embodiment.

Referring to FIG. 20, when it is determined in operation 2010 that a touch of a swipe type to a frame area (e.g., 212 of FIG. 2) is made, in operation 2020, a processor (e.g., 340 of FIG. 3) may verify the area of the touch by an external subject.

In operation 2030, the processor 340 may determine whether the touch area is not smaller than a specified area.

When the touch area is not smaller than the specified area, in operation 2040, the processor 340 may clear the contents of a page corresponding to the swipe direction.

When the touch area is smaller than the specified area, in operation 2050, the processor 340 may perform a page scroll function corresponding to the swipe direction.

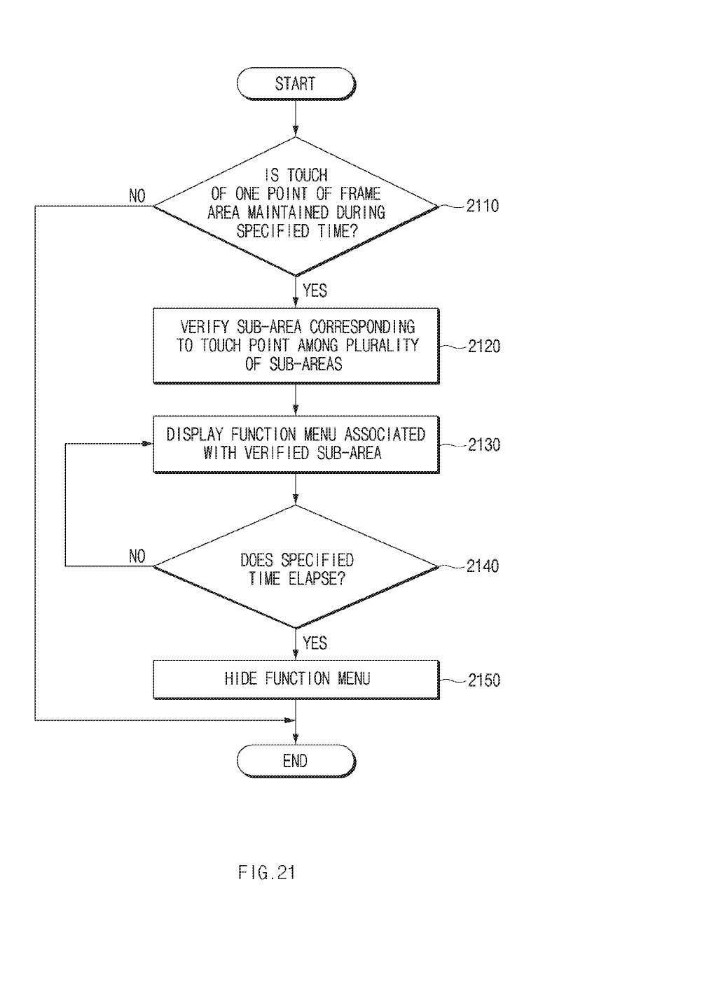

FIG. 21 is a flowchart illustrating a method for displaying a function menu based on a touch, according to an embodiment.

Referring to FIG. 21, in operation 2110, a processor (e.g., 340 of FIG. 3) may determine whether a touch to one point of a frame area (e.g., 212 of FIG. 2) is maintained during a specified time.

When the touch to the one point of the frame area 212 is maintained during the specified time, in operation 2120, the processor 340 may verify a sub-area corresponding to a touch point among a plurality of sub-areas.

In operation 2130, the processor 340 may display a function menu associated with the verified sub-area based on the first mapping information. The first mapping information may include correlation information of a plurality of function menus respectively corresponding to the plurality of sub-areas included in the frame area 212.

In operation 2140, the processor 340 may determine whether a specified time elapses in a state where the function menu is displayed. For example, when the touch to the frame area 212 is released, the processor 340 may determine whether the specified time elapses.

When the specified time elapses, in operation 2150, the processor 340 may hide the function menu.

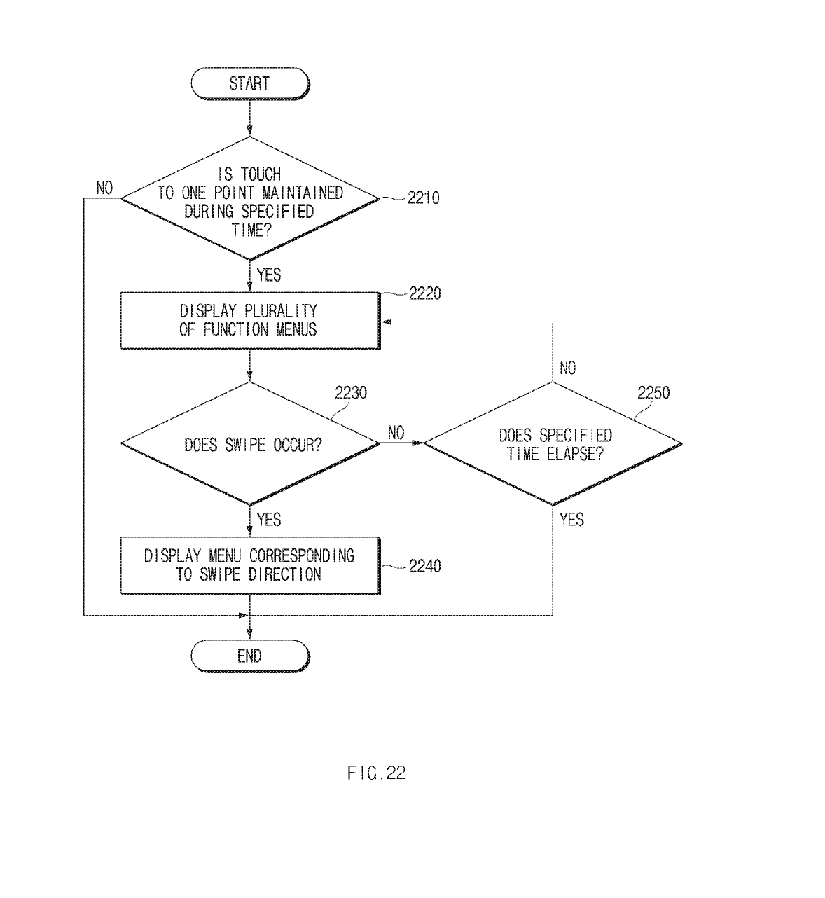

FIG. 22 is a flowchart illustrating a method for displaying a function menu based on a swipe, according to an embodiment.

Referring to FIG. 22, in operation 2210, a processor (e.g., 340 of FIG. 3) may determine whether a touch to one point of a frame area (e.g., 212 of FIG. 2) is maintained during a specified time.

When the touch to the one point of the frame area 212 is maintained during the specified time, in operation 2220, the processor 340 may display a plurality of function menus (e.g., summary information of the plurality of function menus). The processor 340 may display the summary information of the plurality of function menus with respect to the center of the function menu.

In screen 2230, the processor 340 may determine whether a swipe follows after the touch to the one point. When the swipe follows after the touch to the one point, in operation 2230, the processor 340 may verify a direction of the swipe.

In operation 2240, the processor 340 may verify a function menu corresponding to the swipe direction among the plurality of function menus based on the second mapping information, and may overlay the verified function menu on a current page. The second mapping information may include correlation information of a plurality of function menus and a plurality of swipe directions.

When it is determined in operation 2250 that the specific time elapses in a state where the swipe does not follow after the touch to the one point, the processor 340 may terminate the operation of displaying the plurality of function menus.

According to an embodiment, a display device (e.g., 30 of FIG. 3) may include a display that displays an image, a front plate (e.g., 211 to 213 of FIG. 2) that includes a displaying area (e.g., 211 of FIG. 2A) exposing a portion of the display and a non-displaying area (e.g., 212 of FIG. 2A) indicating a border of the display, a sensor circuit (e.g., 310 of FIG. 3) that senses a touch of an external subject to the displaying area and the non-displaying area, and a processor (e.g., 340 of FIG. 3) that is electrically connected with the display and the sensor circuit. The processor may be configured to display a current page of all pages in the display in a drawing mode, to perform, when a touch of the external subject to the displaying area is sensed through the sensor circuit, a drawing function corresponding to the sensed touch, to determine a type of the sensed touch when a touch of the external subject to the non-displaying area is sensed through the sensor circuit, and to update and display the current page based on the type of the sensed touch.

The front plate may include an outer border and an inner border, a height of the outer border exceeding a height of the inner border. The sensor circuit may include a plurality of light emitting elements (e.g., 241 and 242 of FIG. 2C) and a plurality of photodetectors (e.g., 243 and 244 of FIG. 2C), and the plurality of light emitting elements and the plurality of photodetectors may be arranged on side surfaces of the outer border connected with the inner border so as to face each other, and may form a touch sensing area in which the touch of the external subject to the displaying area and the non-displaying area is sensed.

When the type of the touch is a type of a swipe, the processor may be configured to scroll the current page so as to correspond to a direction and a distance of the swipe.

The processor may be configured to verify an area of the touch of the external subject to the non-displaying area when the type of the touch is a type of a swipe and to clear at least a portion of the current page or at least a portion of all the pages when the touch area is not smaller than a specified area.

The processor may be configured to further verify a direction of the swipe, to clear an area of the current page, which corresponds to the swipe when the direction of the swipe is a first direction, and to clear a page corresponding to the swipe among all the pages when the direction of the swipe is a second direction.

When the type of the touch is a pinch type in which two points of the non-displaying area are touched and then a distance between the two points increases, the processor may be configured to enlarge an area, which corresponds to the two points, of the current page.

The processor may be configured to reduce the area corresponding to the two points to a specified magnification when a double tap touch to the non-displaying area is sensed while the area of the current page corresponding to the two points are enlarged.

According to an embodiment, the display device may further include a memory (e.g., 330 of FIG. 3) in which first mapping information between a plurality of sub-areas included in the non-displaying area and a plurality of function menus is stored. When the type of the touch is a type in which one point of the non-displaying area is touched, the processor may be configured to verify a sub-area associated with the one point among the plurality of sub-areas and to overlay a function menu associated with the verified sub-area among the plurality of function menus on the current page based on the first mapping information.

According to an embodiment, the display device may further include a memory in which second mapping information between a plurality of swipe directions and a plurality of function menus is stored. When the type of the touch is a type in which a swipe follows after the touch to the non-displaying area, the processor may configured to very a direction of the swipe and to overlay a function menu associated with the direction of the swipe among the plurality of function menus on the current page based on the second mapping information.

The processor may be configured to overlay map information indicating a location of the current page of all the pages on the current page while the current page is updated.

According to an embodiment, a touch interface method by a display device (e.g., 30 of FIG. 3), which includes a sensor circuit configured to sense a touch of an external subject to a displaying area (e.g., 211 of FIG. 2A), which exposes a portion of a display, of a front plate and to a non-displaying area (e.g., 212 of FIG. 2A), which indicates a border of the display, of the front plate, may include displaying a current page of all pages in the display in a drawing mode; when a touch of the external subject to the displaying area is sensed through the sensor circuit, performing a drawing function corresponding to the sensed touch; and when a touch of the external subject to the non-displaying area is sensed through the sensor circuit, determining a type of the sensed touch and updating and displaying the current page based on the type of the touch.

The displaying may include scrolling, when the type of the touch is a type of a swipe, the current page so as to correspond to a direction and a distance of the swipe.

The displaying may include verifying an area of the touch of the external subject to the non-displaying area when the type of the touch is a type of a swipe, and clearing at least a portion of the current page or at least a portion of all the pages when the touch area is not smaller than a specified area.

The clearing may include verifying a direction of the swipe, clearing an area of the current page, which corresponds to the swipe when the direction of the swipe is a first direction, and clearing a page corresponding to the swipe among all the pages when the direction of the swipe is a second direction.

The displaying may include, when the type of the touch is a pinch type in which two points of the non-displaying area are touched and then a distance between the two points increases, enlarging an area, which corresponds to the two points, of the current page.

The displaying may include reducing the area corresponding to the two points to a specified magnification when a double tap touch to the non-displaying area is sensed while the area of the current page corresponding to the two points are enlarged.

The displaying may include, when the type of the touch is a type in which one point of the non-displaying area is touched, verifying a sub-area associated with the one point among the plurality of sub-areas, and overlaying a function menu associated with the verified sub-area among the plurality of function menus on the current page, based on first mapping information between a plurality of sub-areas included in the non-displaying area and the plurality of function menus.

The displaying may include, when the type of the touch is a type in which a swipe follows after the touch to the non-displaying area, verifying a direction of the swipe and overlaying a function menu corresponding to the direction of the swipe among the plurality of function menus on the current page, based on second mapping information between a plurality of swipe directions and a plurality of function menus.

According to an embodiment, the method may further include overlaying map information indicating a location of the current page of all the pages on the current page while the current page is updated.

According to an embodiment, a display device (e.g., 30 of FIG. 3) may include a display that displays an image, a front plate (e.g., 211 to 213 of FIG. 2A) that includes a displaying area (e.g., 211 of FIG. 2A) exposing a portion of the display and a non-displaying area (e.g., 212 of FIG. 2A) indicating a border of the display, a sensor circuit (e.g., 310 of FIG. 3) that senses a touch of an external subject to the displaying area and the non-displaying area, and a processor (e.g., 340 of FIG. 3) that is electrically connected with the display and the sensor circuit. The processor may be configured to display a current page of all pages in the display in a drawing mode, to perform, when a touch of the external subject to the displaying area is sensed through the sensor circuit, a drawing function corresponding to the sensed touch, and to update and display the current page when a swipe of the external subject to the non-displaying area is sensed while a touch of the external subject to the non-displaying area is sensed.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the disclosure may be implemented by software (e.g., the program) including an instruction stored in a machine-readable storage media (e.g., an internal memory or an external memory) readable by a machine (e.g., a computer). The machine may be a device that calls the instruction from the machine-readable storage media and operates depending on the called instruction and may include the electronic device (e.g., the display device 30). When the instruction is executed by the processor (e.g., the processor 340), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the disclosure may be executed sequentially, in parallel, repeatedly, or in a heuristic method. Also, at least some operations may be executed in different sequences, omitted, or other operations may be added. Accordingly, it will be understood by those skilled in the art that various changes in form and details may be made therein without departing from the spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A display device comprising:
a display including a displaying area in which a plurality of pixels is disposed and a non-displaying area forming a border of the display, wherein the plurality of pixels is not disposed on the non-displaying area;
a sensor circuit configured to sense a touch by an external subject to the displaying area and the non-displaying area; and
a processor configured to:
based on a first touch by the external subject to the displaying area being sensed through the sensor circuit, perform a drawing function corresponding to the first touch; and
based on a second touch by the external subject to the non-displaying area being sensed through the sensor circuit, determine a type of the second touch; and
control the display to perform a control function based on the type of the second touch.

2. The display device claim 1, wherein the front plate further includes an outer border having a first height and an inner border having a second height is less than the first height,
wherein the sensor circuit includes a plurality of light emitting elements and a plurality of photodetectors, and
wherein the plurality of light emitting elements and the plurality of photodetectors are arranged on side surfaces of the outer border connected with the inner border so as to face each other, and to form a touch sensing area in which the first touch and the second touch by the external subject are sensed.

3. The display device of claim 1, wherein the processor is further configured to, based on the type of the second touch being a swipe, scroll the current page so as to correspond to a direction and a distance of the swipe.

4. The display device of claim 1, wherein the processor is further configured to:
based on the type of the second touch being a swipe, verify a touch area of the second touch by the external subject to the non-displaying area; and
based on the touch area not being smaller than a specified area, clear at least a portion of the current page or at least a portion of all the pages.

5. The display device of claim 4, wherein the processor is further configured to:
further verify a direction of the swipe;
based on the direction of the swipe being a first direction, clear an area of the current page, which corresponds to the swipe; and
based on the direction of the swipe being a second direction, clear a page corresponding to the swipe among all the pages.

6. The display device of claim 1, wherein the processor is further configured to, based on the type of the second touch being a pinch in which two points of the non-displaying area are touched and then a distance between the two points increases, enlarge an area, which corresponds to the two points, of the current page.

7. The display device of claim 6, wherein the processor is further configured to, based on a double tap touch to the non-displaying area being sensed in a state where the area of the current page corresponding to the two points is enlarged, reduce the area corresponding to the two points to a specified magnification.

8. The display device claim 1, further comprising a memory configured to store first mapping information between a plurality of sub-areas included in the non-displaying area and a plurality of function menus,
wherein the processor is further configured to:
based on the type of the second touch being a type in which one point of the non-displaying area is touched, verify a sub-area associated with the one point among the plurality of sub-areas; and
overlay a function menu associated with the verified sub-area among the plurality of function menus on the current page based on the first mapping information.

9. The display device claim 1, further comprising a memory configured to store second mapping information between a plurality of swipe directions and a plurality of function menus,
wherein the processor is further configured to:
based on the type of the second touch being a type in which a swipe follows after the second touch to the non-displaying area, verify a direction of the swipe; and
overlay a function menu associated with the direction of the swipe among the plurality of function menus on the current page based on the second mapping information.

10. The display device of claim 1, wherein the processor is further configured to overlay map information indicating a location of the current page among all the pages on the current page while the current page is updated.

11. A touch interface method of a display device which comprises a display including a displaying area in which a plurality of pixels is disposed and a non-displaying area forming a border of the display, and a sensor circuit, wherein the plurality of pixels is not disposed on the non-displaying area, the method comprising:
based on a first touch by an external subject to the displaying area being sensed through the sensor circuit, performing a drawing function corresponding to the first touch; and
based on a second touch by the external subject to the non-displaying area being sensed through the sensor circuit, determining a type of the second touch and updating and displaying the current page based on the type of the second touch; and
controlling the display to perform a control function based on the type of the second touch.

12. The touch interface method of claim 11, wherein the displaying comprises, based on the type of the second touch being a swipe, scrolling the current page so as to correspond to a direction and a distance of the swipe.

13. The touch interface method of claim 11, wherein the displaying comprises:
based on the type of the second touch being a swipe, verifying a touch area of the second touch by the external subject to the non-displaying area; and
based on the touch area not being smaller than a specified area, clearing at least a portion of the current page or at least a portion of all the pages.

14. The touch interface method of claim 13, wherein the clearing comprises:
verifying a direction of the swipe;
based on the direction of the swipe being a first direction, clearing an area of the current page, which corresponds to the swipe; and
based on the direction of the swipe being a second direction, clearing a page corresponding to the swipe among all the pages.

15. The touch interface method of claim 11, wherein the displaying comprises, based on the type of the second touch being a pinch in which two points of the non-displaying area are touched and then a distance between the two points increases, enlarging an area, which corresponds to the two points, of the current page.

16. The touch interface method of claim 15, wherein the displaying comprises, based on a double tap touch to the non-displaying area being sensed in a state where the area of the current page corresponding to the two points is enlarged, reducing the area corresponding to the two points to a specified magnification.

17. The touch interface method of claim 11, wherein the displaying comprises:
based on the type of the second touch being a type in which one point of the non-displaying area is touched, verifying a sub-area associated with the one point among a plurality of sub-areas included in the non-displaying area; and
overlaying a function menu associated with the verified sub-area among a plurality of function menus on the current page, based on first mapping information between the plurality of sub-areas and the plurality of function menus.

18. The touch interface method of claim 11, wherein the displaying comprises:
based on the type of the second touch being a type in which a swipe follows after the touch to the non-displaying area, verifying a direction of the swipe; and
overlaying a function menu corresponding to the direction of the swipe among a plurality of function menus on the current page, based on second mapping information between a plurality of swipe directions and the plurality of function menus.

19. The touch interface method claim 11, further comprising overlaying map information indicating a location of the current page among all the pages on the current page while the current page is updated.

20. A display device comprising:
a display including a displaying area which a plurality of pixels is disposed and a non-displaying area forming a border of the display, wherein the plurality of pixels is not disposed on the non-displaying area;
a sensor circuit configured to sense a touch by an external subject to the displaying area and the non-displaying area; and
a processor configured to:
control the display to display, in a drawing mode, a current page among all pages;
based on a first touch by the external subject to the displaying area being sensed through the sensor circuit, perform a drawing function corresponding to the first touch; and
based on a swipe of the external subject to the non-displaying area being sensed while a second touch by the external subject to the non-displaying area is sensed, control the display to update and display the current page.
